(19) United States
(12) Patent Application Publication
(10) Pub. No.: US 2009/0193101 A1
(43) Pub. Date: Jul. 30, 2009

(54) MULTIMEDIA DATA TRANSMITTING APPARATUS AND MULTIMEDIA DATA MANAGEMENT METHOD

(75) Inventors: Toshihiko MUNETSUGU, Osaka (JP); Yuki HORII, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/357,678

(22) Filed: Jan. 22, 2009

Related U.S. Application Data
(60) Provisional application No. 61/023,249, filed on Jan. 24, 2008.

(51) Int. Cl. G06F 15/16

(52) U.S. Cl. 709/219

(57) ABSTRACT

To provide, in a multi-user environment, a multimedia data transmitting apparatus which prevents a content for which playing is paused by a user from being deleted by another user, and allows playing to be resumed. The multimedia data transmitting apparatus includes: a content managing unit which holds a content and an attribute thereof; and a judging unit which judges, when deletion of the content is requested, whether or not deletion is possible for the content, based on the attribute. The judging unit judges that deletion is possible when the attribute does not indicate either “currently played” or “playing paused”, and to judge that the deletion is not possible when the attribute indicates “currently played” or “playing paused”, and the content managing unit deletes the content when said judging unit judges that deletion is possible.

### BACKGROUND OF THE INVENTION

(1) Field of the Invention

The present invention relates to a multimedia data transmitting apparatus having a server function which provides digitalized multimedia content data via a network such as a home network, and to a multimedia data management method used in the multimedia data transmitting apparatus.

(2) Description of the Related Art

In recent years, digitalization of television broadcasting such as in terrestrial broadcasting and satellite broadcasting is advancing. Furthermore, DVR for recording a TV-program in a recording medium for digital data such as a Hard Disk Drive (HDD), a Blu-Ray Disc (BD), and a Digital Versatile Disc (DVD) is becoming popular. With this, digitalized multimedia content that can be used in households is increasing.

Meanwhile, with the development of the broadband environment, Internet access from households is becoming widespread. Accordingly, the spread of the so-called home network, in which the respective rooms in a house are connected through an IP network, is also advancing.

With such a situation, a digital broadcast received by a digital broadcast receiver in the house, or a digital content stored in a recorder can now be viewed at other rooms, using the home network.

With regard to such sharing of digital content using a home network, there is an active move to make this possible not only between the above-mentioned CE devices, but also between all devices connected to a home network, including personal computers (PC) and Personal Digital Assistants (PDA). To be more specific, standardization organizations such as the Digital Living Network Alliance (DLNA) have laid-out and made public standards and implementing guidelines for this purpose.

In general, methods defined in UPnP DA (Universal Plug & Play Device Architecture) are used in device discovery and the exchange of information on the functions provided from the server, between the server (for example a set top box or DVR receiving a digital broadcast) and the client (for example, a personal computer or a digital player) in the home network. Furthermore, methods defined in UPnP AV (UPnP AV Architecture) (Non Patent Reference 1: UPnP AV Architecture: 1 For UPnP™ Version 1.0, Jun. 25, 2002) are used in the exchange of information on the contents provided from the server. In UPnP AV, upon receiving an inquiry from the client, the server responds with a list of provided contents and the attributes of each of the contents. Furthermore, as a mandatory protocol for transmission of content data, Hypertext Transfer Protocol (HTTP) is used in DLNA.

In this manner, the sharing of a digital content using the home network is utilized in a multi-user, multi-client environment in which the use of the same content by plural users is carried out. Furthermore, even in playing via a network, a function equivalent to a function performed by a DVR device such as trick play is required. Here, the resume function in which playing is stopped once and the continuation is viewed later on, and the deleting of a content are typical of such a function.

However, in a multi-user environment using the home network, there are cases where a user, other than the user who is currently playing or has paused the playing of the content, deletes the content unaware that the content is currently playing or playing is currently paused. Conventionally, in a CE device such as a DVR, the deletion of a content is performed when protection against deletion is not explicitly set by a user. Furthermore, in a PC and the like, access rights to respective contents are managed, and deletion is performed when requested by a user having the right to delete and the content is not being used at that point in time. In such manner, there is the problem that, since deletion of the content can be performed even when the playing is currently paused, the user cannot properly perform the resumption of the content.

### SUMMARY OF THE INVENTION

Consequently, the present invention is conceived in view of the aforementioned problem and has as an object to provide a multimedia data transmitting apparatus and a multimedia data management method which can prevent inappropriate deletion of a content.

In order to solve the aforementioned conventional problem, the multimedia data transmitting apparatus of the present invention is a multimedia data transmitting apparatus which transmits multimedia data representing at least one of video and audio to a client device via a network, in response to a request from the client device, the multimedia data transmitting apparatus includes: a content managing unit which holds a content to be transmitted to the client device, as the multimedia data, and an attribute indicating a state of playing of a content; and a judging unit which judges, when deletion of the held content is requested, whether or not the deletion is possible for at least a part of the content, based on the attribute, wherein the judging unit judges that the deletion is possible when the attribute does not indicate either a state in which the content is being played or a state in which the playing of the content is paused, and judges that the deletion is not possible when the attribute indicates the state in which the content is being played or the state in which the playing of the content is paused, and the content managing unit deletes the at least a part of the content when the judging unit judges that the deletion is possible.

With this, it becomes possible to prevent the deletion of a content for which playing has been paused, and the user can resume the playing at all times.

Furthermore, the content may be chronologically divided into plural segments, the content managing unit may perform deletion on a per segment basis when the content is composed of the plural segments, and the judging unit may judge that the deletion is not possible for a segment which includes a position of current playing or a position at which playing is paused, among the plural segments.

With this, it becomes possible to limit, to a segment, the range that is deemed necessary for playing resumption, the user can resume the playing, and the consumption of the capacity of the recording medium provided in the multimedia data transmission apparatus can be suppressed.

Furthermore, the content managing unit may further hold a collection of contents that are associated as a series, and the judging unit may judge that deletion is not possible for the content for which the deletion is requested, when the attribute of at least one of the contents included in a same series as the content for which the deletion is requested indicates the state in which the content is being played or the state in which the playing of the content is paused.

With this, it becomes possible to prevent the deletion of a content in a series for which playing has been paused by the user, and the user can be guaranteed of the resumption of playing at any time and the playing of the contents in the series.

Furthermore, the judging unit may further have a judgment condition other than the attribute and may judge, according to the judgment condition, whether or not the deletion is possible for the content for which the deletion is requested, when the content for which the deletion is requested has the attribute.

With this, even when playing is paused, appropriate content deletion becomes possible by carrying out the deletion of the content when a specified condition is satisfied. This has the effect of allowing the suppression of recording medium capacity consumption.

Furthermore; the multimedia data transmitting apparatus may further include a deleting condition managing unit which accepts a deleting condition for allowing the deletion of a content, wherein, when the judging unit judges that the deletion is not possible, the judging unit may provide the deleting condition to the deleting condition managing unit, and the deleting condition managing unit may instruct the deletion of the content to the content managing unit when the deleting condition is satisfied.

Conventionally, judgment for whether or not deletion is possible is performed only when deletion is requested, and the deletion is carried out when it is judged as being possible. Therefore, when the execution of the deletion of the currently played or playing-paused content is limited, unless a new request for deletion is sent, such content will not be deleted even when, for example, playing is resumed and viewing of such content is finished. This causes a different problem in that, since content data cannot be deleted appropriately, recording media capacity is consumed and the TV program desired by the user cannot be recorded or stored.

However, with the above-described structure, even when in the currently played or playing paused state, appropriate content deletion becomes possible by carrying out the deletion of the content when a specified condition is satisfied. This has the effect of allowing the suppression of recording medium capacity consumption.

Furthermore, the attribute of the content may indicate either a currently played state in which the content is being played or a playing paused state in which the playing of the content is paused, and the deleting condition may be that the attribute of the content is updated by the content managing unit so as not to indicate either of the currently played state or the playing paused state.

Accordingly, since the deleting condition is assumed to be when the content attribute is no longer the state in which the content is being played and no longer the state in which the playing of the content is paused, it is possible to carry out the deletion of the content at the time when the playing of the content finishes, and this has the effect of allowing the suppression of recording medium capacity consumption.

Furthermore, the content managing unit may hold plural attributes for the content, the plural attributes of the content may each indicate either a currently played state in which the content is being played or a playing paused state in which the playing of the content is paused, and the deleting condition may be that at least one of the plural attributes of the content is updated by the content managing unit so as not to indicate either of the currently played state or the playing paused state.

Accordingly, since the deleting condition is assumed to be when at least one of the plural attributes of the content is no longer the state in which the content is being played and no longer the state in which the playing of the content is paused, it is possible to carry out the deletion of the content at the time when, due to the ending of the playing of the content, at least one of the plural attributes of the content is no longer the state in which the content is being played and no longer the state in which the playing of the content is paused, and this has the effect of allowing the suppression of recording medium capacity consumption.

Furthermore, the content managing unit may hold plural attributes for the content, the plural attributes of the content may each indicate either a currently played state in which the content is being played or a playing paused state in which the playing of the content is paused, and the deleting condition may be that the plural attributes of the content are each updated by the content managing unit so as not to indicate either of the currently played state or the playing paused state.

Accordingly, since the deleting condition is assumed to be when the respective plural attributes of the content are no longer the state in which the content is being played and no longer the state in which the playing of the content is paused, it is possible to carry out the deletion of the content at the time when the playing of the content ends and all of the plural attributes of the content are no longer the state in which the content is being played and no longer the state in which the playing of the content is paused, and this has the effect of allowing the suppression of recording medium capacity consumption.

Furthermore, the deleting condition may be the passing of a specified time.

With this, even when playing is paused, appropriate content deletion becomes possible by regarding the content as unnecessary and deleting the content after a specified time has passed. This has the effect of allowing the suppression of recording medium capacity consumption.

Furthermore, the deleting condition may be that a remaining capacity of a recording media included in the multimedia transmitting apparatus, for recording the content has fallen below a specified value.

This has the effect of allowing the suppression of recording medium capacity consumption, even when playing is paused, by deleting the content when the capacity of the recording medium becomes small.

Furthermore, the multimedia data transmitting apparatus may further include a Java executing unit which executes a Java application program, wherein, when the attribute indicates the state in which the content is being played or the state in which the playing of the content is paused, the judging unit may judge whether or not the deletion is possible for the at least a part of the content for which the deletion is requested by inquiring with the Java application program executed by the Java executing unit.

With this, control for deleting a content which is being played or for which playing is paused can be performed by a downloaded Java application program, and more appropriate management of content deletion, such as allowing judgment condition changing by the Java application program, becomes possible.

Furthermore, the content may be chronologically divided into plural segments, the content managing unit may perform deletion on a per segment basis when the content is composed of the plural segments, and when receiving the inquiry from the judging unit, the Java application program may select either the content or the segment which includes a position of current playing or a position at which playing is paused, and judge whether or not deletion is possible for the selected one.

With this, the Java application program can select the range to be protected from deletion from either the entire content or the segment at which playing is paused, and thus allowing more appropriate management.

Furthermore, the content managing unit may hold a collection of contents that are associated as a series, and when the attribute of at least one of the contents included in a same series as the content for which the deletion is requested indicates the state in which the content is being played or the state in which the playing of the content is paused, the judging unit may judge whether or not the deletion is possible for the content by inquiring with the Java application program.

With this, the control of the deletion of a content included in a series is performed according to the Java application program thereby allowing more appropriate management of content deletion.

It should be noted that the present invention can be implemented, not only as such a multimedia data transmitting apparatus, but also as a method for managing multimedia data used in the multimedia data transmitting apparatus, as a program for causing the multimedia data transmitting apparatus to manage multimedia data using to such method, as a recording medium on which such program is stored, and as an integrated circuit which manages multimedia data using such method.

As described above, according to the multimedia data transmitting apparatus and the multimedia data management method of the present invention, it becomes possible to perform control so as to prevent or defer the deletion of a content that is being played or a content for which playing has been paused by a user or a client, in a multi-client environment or a multi-user environment in which streaming playback of multimedia data is performed using a network such as a home network. With this, even when another user or client requests the deletion of the content, the content can be protected and the user or client can resume the playing of the content.

### FURTHER INFORMATION ABOUT TECHNICAL BACKGROUND TO THIS APPLICATION

As further information about the technical background to this application, the disclosure of U.S. Provisional Application No. 61/023,249 filed Jan. 24, 2008, including specifications, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram for the multimedia content delivery system in an embodiment of the present invention.

FIG. 2 is a block diagram showing an example of the constituent elements of the multimedia data transmitting apparatus 101 that are concerned with content deletion.

FIG. 3 is a flowchart showing an example of the content deletion-related processing performed by the multimedia data transmitting apparatus 101.

FIG. 4 is a block diagram showing an example of the constituent elements of the multimedia data transmitting apparatus 101 that are concerned with content deletion.

FIG. 5 is a flowchart showing an example of the content deletion-related processing performed by the multimedia data transmitting apparatus 101.

FIG. 6 is a configuration diagram for the multimedia data transmitting apparatus 101 in an embodiment of the present invention.

FIG. 7 is a diagram showing an example of an external view in the case where the input 201 unit is made up of a front panel.

FIG. 8 is a structure diagram for the program structure stored in the multimedia data transmitting apparatus 101 in an embodiment of the present invention.

FIG. 9A is a diagram showing an example of an on-screen display in the present invention.

FIG. 9B is a diagram showing an example of an on-screen display in the present invention.

FIG. 10 is a diagram showing an example of TV program information stored in the second memory 203 of the present invention.

FIG. 11 is a diagram showing an example of channel information stored in the second memory 203 of the present invention.

FIG. 12A is diagram showing an example of a channel identifier stored in the second memory 203 of the present invention.

FIG. 12B is diagram showing an example of a channel identifier stored in the second memory 203 of the present invention.

FIG. 12C is diagram showing an example of a channel identifier stored in the second memory 203 of the present invention.

FIG. 13 is diagram showing an example of a PAT stored in the second memory 203 of the present invention.

FIG. 14 is diagram showing an example of a PMT stored in the second memory 203 of the present invention.

FIG. 15 is diagram showing an example of an AIT stored in the second memory 203 of the present invention.

FIG. 16 is diagram showing an example of a file system stored in the second memory 203 of the present invention.

FIG. 17 is diagram showing an example of the structure of data stored in the second memory 203 of the present invention.

FIG. 18 is diagram showing an example of the attribute information of multimedia data in an embodiment of the present invention.

FIG. 19 is diagram showing an example of the attribute information table in an embodiment of the present invention.

FIG. 20 is diagram showing an example of the URI table in an embodiment of the present invention.

FIG. 21 is diagram showing examples of the Java APIs included in the Content Manager 405k.

FIG. 22 is diagram showing an example of the Java class (Metadata class) definition used by the Content Manager 405k.

FIG. 23 is diagram showing an example of the attribute information of multimedia data in an embodiment of the present invention.

FIG. 24 is diagram showing an example of the Java interface definition used by the Content Manager 405k.

FIG. 25 is diagram showing an example of the Java class (DeleteCondition class) definition used by the Content Manager 405k.

FIG. 26 is an explanatory diagram for describing handlers.

FIG. 27 is a diagram showing the operation in which a handler is registered through the method registerJudgeHandler( ).

FIG. 28 shows an example of the Java interface (TimerHandler interface) definition used by the Content Manager 405k.

FIG. 29 shows an example of the Java interface (ObservHandler interface) definition used by the Content Manager 405k.

FIG. 30 is diagram showing an example of the attribute information of multimedia data in an embodiment of the present invention.

FIG. 31 is a configuration diagram for the multimedia data receiving apparatus 102 in an embodiment of the present invention.

FIG. 32 is a structure diagram for the program structure stored in the multimedia data receiving apparatus 102 in the embodiment.

FIG. 33 is an explanatory diagram for describing the deletion of a segment as a unit of processing.

FIG. 34 is an explanatory diagram for describing the processing operation when the deletion of a content belonging to a series is requested.

### DESCRIPTION OF THE PREFERRED EMBODIMENT(S)

Hereinafter, the embodiment of the present invention shall be described with reference to the drawings.

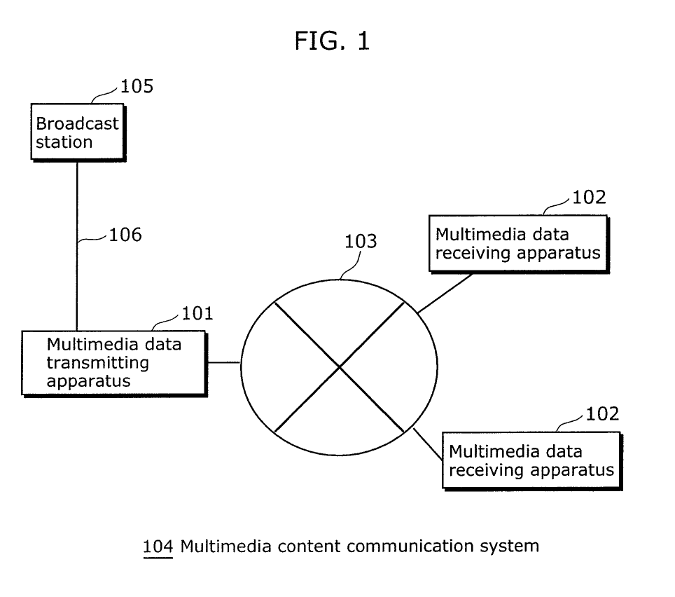

FIG. 1 is a configuration diagram for the multimedia content communication system in the embodiment of the present invention. In FIG. 1, a multimedia content communication system 104 includes a multimedia data transmitting apparatus 101 in the present invention, two multimedia data receiving apparatuses 102 which are client devices, and a network 103. The multimedia data transmitting apparatus 101 and the two multimedia data receiving apparatuses 102 are connected to the network 103, and are capable of mutual communication via the network 103. In addition, the multimedia data transmitting apparatus 101 is connected to a cable television broadcast station 105 by a cable 106.

The multimedia data transmitting apparatus 101 in the present embodiment is a CATV Set Top Box (STB) which receives a digital broadcast and includes a network interface and a storage unit for storing multimedia data. The multimedia data transmitting apparatus 101 is connected to the broadcast station 105 via the cable 106. In addition, the multimedia data transmitting apparatus 101 stores the multimedia data of a digital broadcast content received from the broadcast station 105, in the storage unit. Furthermore, the multimedia data transmitting apparatus 101 is connected to the network 103 via the network interface. In addition, the multimedia data transmitting apparatus 101 receives, through the network 103, requests transmitted from the multimedia data receiving apparatus 102. Subsequently, in response to the requests, the multimedia data transmitting apparatus 101 transmits, to the multimedia data receiving apparatus 102, through the network 103, the information and attributes or the multimedia data of each of the contents of the digital broadcasts received, or those of each of the stored contents. Furthermore, when the multimedia data receiving apparatus 102 pauses the playing, that is, in the case where receiving of multimedia data is paused, the multimedia data transmitting apparatus 101 adds such play-pausing, as an attribute, to the content. Such attribute shall be referred to, hereafter, as a playing paused attribute. The playing paused attribute is added when the playing of a content is paused, and removed when the playing is resumed.

It should be noted that the playing paused attribute may include the playing pause position as information. Furthermore, the playing paused attribute may be managed on a per client device or on a per user basis. In other words, plural playing paused attributes may be added to the same content. In this case, when the corresponding paused playing is resumed, the playing paused attribute is removed.

Moreover, although the digital broadcast content stored by the multimedia data transmitting apparatus 101 in the storage unit is data in the MPEG2-TS format, the present invention is not dependent on the content format.

The multimedia data receiving apparatus 102 transmits a transmission request for a list of contents that can be provided, to the multimedia data transmitting apparatus 101, according to a user's request. Subsequently, the multimedia data receiving apparatus 102 receives the list of contents from the multimedia data transmitting apparatus 101, as a response to the request, and presents the list to the user. In addition, the multimedia data receiving apparatus 102 transmits, to the multimedia data transmitting apparatus 101, a transmission request for the multimedia data of a content selected by the user. The multimedia data receiving apparatus 102 receives the requested multimedia data as a response to the request, and presents this to the user by playing. In addition, upon receiving a request for trick play such as fast forward or rewind from the user, the multimedia data receiving apparatus 102 implements the trick play by temporarily terminating the communication of multimedia data, issuing a new transmission request for the portion required for the trick play, and receiving and playing the multimedia data. Furthermore, the playing by the multimedia data receiving apparatus 102 can be paused by temporary stopping or stopping. Furthermore, the multimedia data receiving apparatus 102 can perform the resumption of a paused playing, referred to as resume. Here, resumption may be performed in the multimedia data receiving apparatus 102, by storing the position where playing is paused and requesting data transmission by specifying the resuming position to the multimedia data transmitting apparatus 101, and resume-playing may also be performed in the multimedia data receiving apparatus 102 by requesting resume-playing to the multimedia data transmitting apparatus 101 and receiving data from the resuming position.

The network 103 is a home network established in the household, and is an IP network configured of Ethernet, wireless LAN, and so on.

Hereinafter the communication and respective operations of the multimedia data transmitting apparatus 101 and the multimedia data receiving apparatus 102 shall be described.

When connected to the network 103, the multimedia data transmitting apparatus 101, which is a multimedia data server, notifies other devices that it is a server that can provide services, by broadcasting to the network 103. In addition, according to a request from another device connected to the network 103, the multimedia data transmitting apparatus 101 transmits services provided and the access methods thereof to the request-source apparatus. Furthermore, when connected to the network 103, the multimedia data receiving apparatus 102, which is a client device, searches for server devices connected to the network 103, and obtains what functions each of the server devices have. Since such communication can be carried out as defined in the UPnP Device Architecture (DA), in the same manner as defined in DLNA, detailed description shall be omitted. With this, the multimedia data receiving apparatus 102 can recognize that the multimedia data transmitting apparatus 101 is a multimedia server which is connected to the network 103.

Hereinafter, the communication of multimedia data between the multimedia data transmitting apparatus 101 and the multimedia data receiving apparatus 102 shall be described in sequence.

First, the multimedia data receiving apparatus 102 issues a transmission request for a list of contents that can be provided, to the multimedia data transmitting apparatus 101. Then, upon receiving the request, the multimedia data transmitting apparatus 101 retrieves the contents that can be provided, and responds to the multimedia data receiving apparatus 102, with the list. This communication can be carried out using the Browse or Search in the UPnP AV Content Directory Service (CDS), and thus detailed description shall be omitted.

Upon receiving, from the multimedia data receiving apparatus 102, the transmission request for the list of contents that can be provided, to the multimedia data transmitting apparatus 101 responds with a list of the contents stored in the storage unit. Since a list defined in the UPnP AV or DLNA can be used for the list to be transmitted, detailed description shall be omitted.

Receiving the provided content list, the multimedia data receiving apparatus 102 presents this list to the user. Then, the multimedia data receiving apparatus 102 requests, to the multimedia data transmitting apparatus 101, the transmission of multimedia data of the content selected by the user. The multimedia data transmitting apparatus 101 reads the requested content data from the storage unit, and transmits this to the multimedia data receiving apparatus 102. In the communication of the multimedia data, communication is performed using HTTP which is a mandatory protocol in DLNA. For example, when the Uniform Resource Identifier (URI) of the multimedia data is http://192.168.0.3/AVData/0001.m2ts, an HTTP request such as that in the example below is issued from the multimedia data receiving apparatus 102 to the multimedia data transmitting apparatus 101.

GET http://192.168.0.3/AVData/0001.m2ts HTTP/1.1
Host: 192.168.0.3
Date: Thr Jan 11 15:00:00 2007 GMT
User-Agent: AVT Client
Connection: Keep-Alive

At this time, the multimedia data transmitting apparatus 101 reads the specified multimedia data from the storage unit, and transmits the read multimedia data to the multimedia data receiving apparatus 102. At this time, an HTTP response such as the example below is transmitted from the multimedia data transmitting apparatus 101 to the multimedia data receiving apparatus 102.

HTTP/1.1 200 OK
Date: Thr Jan 11 15:00:01 2007 GMT
Server: AVT Server
Connection: Keep-Alive
Content-Type: video/mpeg
Content-Length: 1880000000
(Empty line)
[1880000000-bytes data]

While receiving the multimedia data transmitted from the multimedia data transmitting apparatus 101, the multimedia data receiving apparatus 102 decodes the coded data in the MPEG2-TS and plays the decoded data.

In addition, when trick play is requested by the user, the multimedia data receiving apparatus 102 temporarily stops the receiving of the continuing multimedia data. This is performed by terminating the HTTP session. Alternatively, the stopping of data transmission may be requested to the multimedia data transmitting apparatus 101 in a different session. Next, in accordance with the type of the trick play, the multimedia data receiving apparatus 102 judges the section of the multimedia data required for the trick play, and issues a transmission request for only such section to the multimedia data transmitting apparatus 101. The required section is a GOP which is the smallest unit of random access in MPEG Video or an I-frame. In this case, the multimedia data receiving apparatus 102 specifies the transmission start request position and the transmission end request position and requests for data transmission to the multimedia data transmitting apparatus 101. This is performed by transmitting a request including a Range header defined in HTTP 1.1. For example, in the case where the start of the multimedia data is 0 and data from the 47940th byte position to the 95879th byte position is to be obtained, the HTTP request shown below is transmitted.

GET http://192.168.0.3/AVData/0001.m2ts HTTP/1.1
Host: 192.168.0.3
Date: Thr Jan 11 15:00:00 2007 GMT
User-Agent: AVT Client
Connection: Keep-Alive
Range: bytes=47940-95879

When receiving such an HTTP request, the multimedia data transmitting apparatus 101 reads, from the storage unit, the data in the specified range of the multimedia data, and transmits the read data as a response. In the above-described example, the multimedia data transmitting apparatus 101 reads the data from the 47940th byte position to the 95879th byte position, and transmits a response such as that shown below.

HTTP/1.1 200 OK
Date: Thr Jan 11 15:00:01 2007 GMT
Server: AVT Server
Connection: Keep-Alive
Content-Type: video/mpeg
Content-Length: 47940
Content-Range: bytes=47940-95879
(Empty line)
[47940-bytes data]

Here, the Content-Length header represents the number of data to be transmitted by the number of bytes, and the Content-Range header represents the range within the multimedia data of the data to be transmitted. For details, refer to the HTTP 1.1 Specification described in RFC2616.

As described above, the multimedia data receiving apparatus 102 performs trick play by repeating the determining of the range of required data and the receiving and displaying of only such data, in accordance with the type of the trick play such as fast forward, rewind, or slow.

Furthermore, the multimedia data range specification as described above may be performed by using a TimeSeekRange.dlna.org header defined in DLNA. TimeSeekRange.dlna.org header specifies a position in the playing time information of the content, instead of byte positions. For details, refer to the DLNA Guidelines published by DLNA.

Alternatively, instead of the multimedia data receiving apparatus 102 performing trick play by its determining the data section required for the trick play and making a request for the data, trick play may be performed by a method in which the multimedia data transmitting apparatus 101 determines the data required for trick play and transmitting the required data when the multimedia data transmitting apparatus 101 receives the HTTP GET request with PlaySpeed.dlna.org header defined in DLNA. For example, when double speed playing is requested by the user, the multimedia data receiving apparatus 102 transmits an HTTP request such as that shown below, to the multimedia data transmitting apparatus 101.

GET http://192.168.0.3/AVData/0001.m2ts HTTP/1.1
Host: 192.168.0.3
Date: Thr Jan 11 15:00:00 2007 GMT
User-Agent: AVT Client
Connection: Keep-Alive
PlaySpeed.dlna.org: speed=2.0

When receiving such an HTTP request, the multimedia data transmitting apparatus 101 selects the data sections from the multimedia data and transmits the selected data sections to the multimedia data receiving apparatus 102, in accordance with the specified playing speed. Alternatively, the multimedia data transmitting apparatus 101 may create and transmit the data for the trick play using a method in which the specified multimedia data trick play is performed in the multimedia data transmitting apparatus 101 and the data is encoded. Refer to the DLNA Guidelines with regard to a PlaySpeed.dlna.org header.

When receiving an HTTP request for data transmission from the multimedia data receiving apparatus 102, the multimedia data transmitting apparatus 101 adds an attribute “currently played” to such multimedia data. Then, when the entire data of the multimedia data has been transmitted, the multimedia data transmitting apparatus 101 removes the added “currently played” attribute. Furthermore, when the multimedia data receiving apparatus 102 terminates the HTTP session for carrying out data communication without playing the entire data, the multimedia data transmitting apparatus 101 removes the “currently played” attribute from the multimedia data and adds a new attribute “playing paused”. Then, when receiving a transmission request for the multimedia data from the multimedia data receiving apparatus 102, the multimedia data transmitting apparatus 101 removes the “playing paused” attribute from the multimedia data and adds the “currently played” attribute again.

It should be noted that it is also acceptable that in the case where the multimedia data receiving apparatus 102 terminates the HTTP session without receiving the entire data, the multimedia data transmitting apparatus 101 does not add the “playing paused” attribute when transmission of a specific percentage of the data amount has been completed. This is useful, for example, when the main feature of a TV-program has ended and only commercial messages remain.

Next, content deletion by the multimedia data transmitting apparatus 101 shall be described. The multimedia data transmitting apparatus 101 receives a request for content deletion from the user operating the multimedia data transmitting apparatus 101. This is performed by operating a remote control or front panel of the multimedia data transmitting apparatus 101. Furthermore, a request for content deletion is sent to the multimedia data transmitting apparatus 101 from the multimedia data receiving apparatus 102 and also from other client devices. This is carried out using a DestroyObject action defined in UPnP AV CDS, and the like.

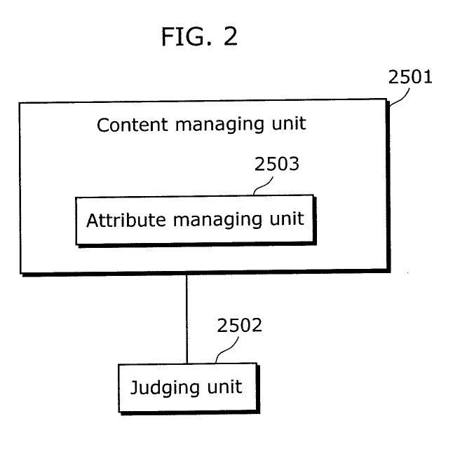

FIG. 2 shows a block diagram of the constituent elements within the multimedia data transmitting apparatus 101 that are concerned with content deletion. In FIG. 2, the multimedia data transmitting apparatus 101 includes a content managing unit 2501 which manages contents and carries out the storage and deletion thereof, and a judging unit 2502 which judges whether or not deletion of a content is possible when a content deletion request is received. Furthermore, the content managing unit 2501 includes an attribute managing unit 2503 which manages the attributes of each content and carries out the addition and removal of attributes.

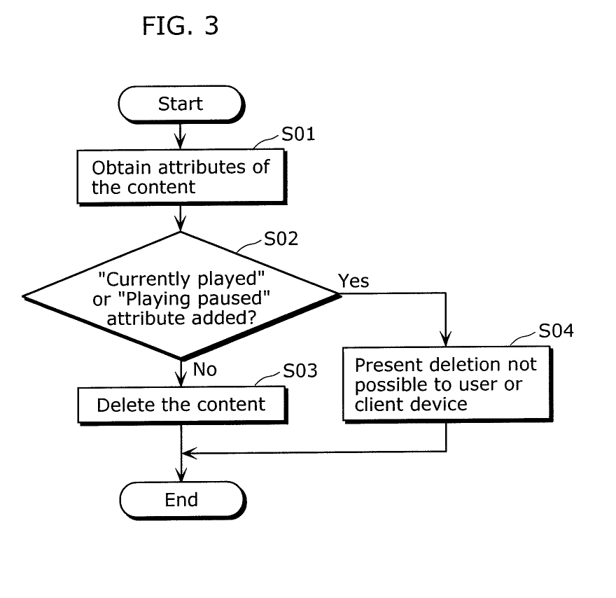

FIG. 3 is a flowchart of processing when the multimedia data transmitting apparatus 101 receives a content deletion request. In FIG. 3, upon receiving a content deletion request, the multimedia data transmitting apparatus 101 first obtains the attributes of the content from the attribute managing unit 2503 by requesting the content managing unit 2501, in step S01. Next, the judging unit 2502 performs judging in step S02. First, when neither the “currently played” nor the “playing paused” attribute is added to the content, the judging unit 2502 judges that deletion is possible. Furthermore, in step 502, when either the “currently played” or the “playing paused” attribute is added to the content, the judging unit 2502 judges that deletion is not possible.

When it is judged that the content can be deleted in step S02, the multimedia data transmitting apparatus 101 proceeds to step S03, deletes the multimedia data of the content by requesting the content managing unit 2501, and ends the processing. Furthermore, when it is judged that the content cannot be deleted in step S02, the multimedia data transmitting apparatus 101 proceeds to step S04, notifies such fact to the user or the client device which transmitted the request, and ends the processing.

It should be noted that although the possibility of deletion is judged by whether or not either the “currently played” or the “playing paused” attribute is added to the content, the judging unit 2502 may perform the judgment in consideration of other attributes as well. For example, even when a content is not added with the “currently played” and “playing paused” attribute, a judgment of deletion not possible may be made when it is a content for which protection has been set by the user, a service operator, and the like.

Furthermore, upon receiving a content deletion request, and when the “currently played” or the “playing paused” attribute is added to the content, the multimedia data transmitting apparatus 101 adds a “deletion pending” attribute to the content and, subsequently, when a predetermined condition is satisfied, processing for deleting the content may be performed. Such predetermined condition shall be referred to hereafter as a deleting condition. Hereinafter, description shall be carried out using the case of the ending of playing or the lapse of a sufficiently long predetermined time as an example of the deleting condition.

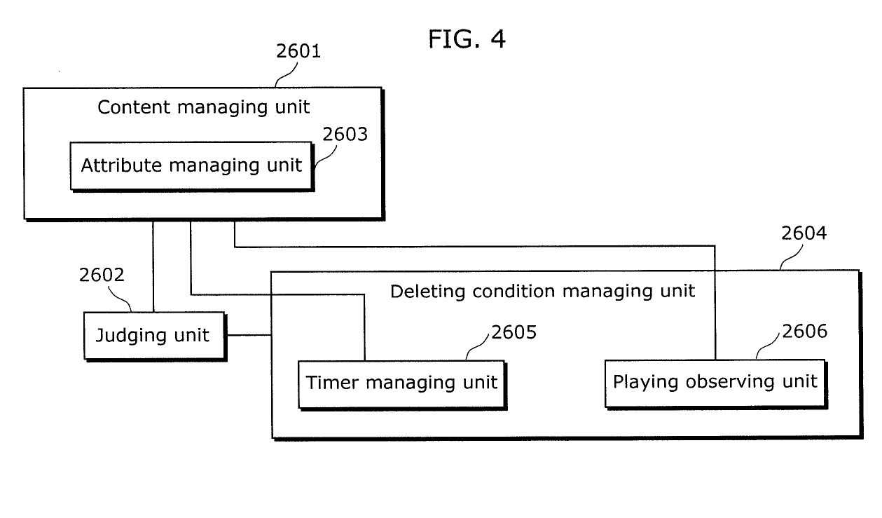

FIG. 4 is a block diagram of the constituent elements within the multimedia data transmitting apparatus 101 that are concerned with content deletion in such a case. In FIG. 4, multimedia data transmitting apparatus 101 includes a content managing unit 2601, a judging unit 2602, and a deleting condition managing unit 2604. The content managing unit 2601 manages contents and carries out the storage and deletion thereof. The judging unit 2602 judges whether or not deletion of a content is possible when a content deletion request is received. Aside from this, in the case where it is judged that the content cannot be deleted, and when it is possible to set a deleting condition for enabling the deletion of the content, the judging unit 2602 sets such deleting condition to the deleting condition managing unit 2604. The content managing unit 2601 includes an attribute managing unit 2603 which manages the attributes of each content and carries out the addition and removal of attributes. Furthermore, the deleting condition managing unit 2604 manages the deleting condition set by the judging unit 2602, and deletes the content by requesting the content managing unit 2601 when the deleting condition is satisfied. The deleting condition managing unit 2604 includes, as constituent elements, a timer managing unit 2605 and a playing observing unit 2606. The timer managing unit 2605 performs, according to an instruction from the deleting condition managing unit 2604, the setting, starting, stopping, and clearing of a timer, and notifying the deleting condition managing unit 2604 that the timer has passed a specified time. Furthermore, the playing observing unit 2606 obtains the attributes of the content from the attribute managing unit 2603 via the content managing unit 2601, and observes the playing of the content and the outputting of content data to the network.

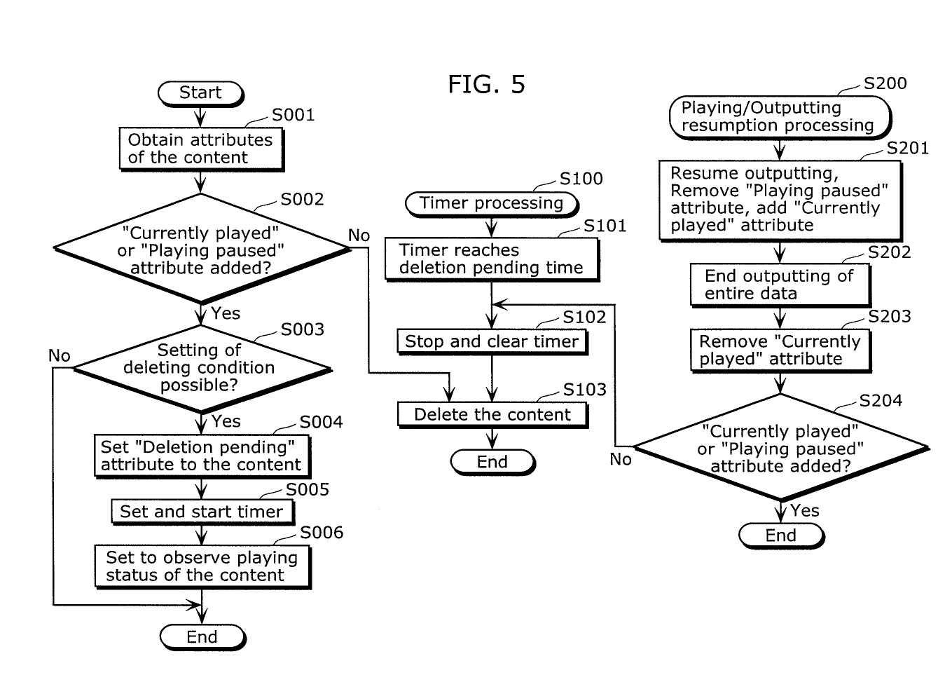

FIG. 5 shows a flowchart of processing performed by the multimedia data transmitting apparatus 101 in this case.

In FIG. 5, upon receiving a content deletion request, the multimedia data transmitting apparatus 101 first obtains the attributes of the content from the attribute managing unit 2603 by requesting the content managing unit 2601, in step S001. Next, the judging unit 2602 performs judging in step S002. First, when neither the “currently played” nor the “playing paused” attribute is added to the content (No in step S002) the judging unit 2602 judges that deletion is possible. In this case, the multimedia data transmitting apparatus 101 proceeds to step S103, deletes the multimedia data of the content by requesting the content managing unit 2601, and ends the processing.

Furthermore, in step S002, when either the “currently played” or the “playing paused” attribute is added to the content (Yes in step S002), the judging unit 2602 proceeds to step S003. In step S003, the judging unit 2602 judges whether or not it is possible to set a deleting condition for the content. This judgment may be made based on other attributes of the content, such as the content being added with a protect-content attribute from the user or service operator, for example. When it is not possible to set a deleting condition for the content (No in step S003), the judging unit 2602 judges that the content cannot be deleted and ends the processing. When a deleting condition can be set for the content (Yes in step S003), the judging unit 2602 proceeds to step S004. In step S004, the judging unit 2602 adds the “deletion pending” attribute to the content by requesting the attribute managing unit 2603 via the content managing unit 2601. In addition, the judging unit 2602 sets the content and the deleting condition therefor to the deleting condition managing unit 2604. Here, the deleting condition is set as the passing of a specific time or the state in which the “currently played” or “playing paused” attribute is not added. It is preferable that the specific time be a time having a sufficient length for the playing to finish, such as a number of days, for example. This time shall be referred to hereafter as deletion pending time. In addition, the processing proceeds to step S005. In step S005, the deleting condition managing unit 2604 makes a setting so as to be notified when the deletion pending time has passed from the starting of the timer, by requesting the timer managing unit 2605. In addition, in step S005, the deleting condition managing unit 2604 causes the timer to start. In addition, proceeding to step S006, the deleting condition managing unit 2604 sets the playing observing unit 2606 to observe the status of the playing of the content.

When the timer starts, the timer processing shown from step S100 is performed. First, when the timer reaches the deletion pending time in step S101, the timer managing unit 2605 notifies such fact to the deleting condition managing unit 2604, and the processing proceeds to step S102. In step S102, the deleting condition managing unit 2604 stops and clears the timer by requesting the stopping and clearing of the timer to the timer managing unit 2605. Next, proceeding to step S103, the deleting condition managing unit 2604 deletes the content by requesting the content managing unit 2601, and ends the processing. The deleting condition managing unit 2604 deletes the content and deletes the attribute of the content by requesting the attribute managing unit 2603. It should be noted that although, in order to facilitate description, it is assumed that the content is deleted when the timer reaches the set time, the processing may be performed again from step S001. On the other hand, when the playing of the content is resumed, the playing/output resumption shown in step S200 is performed. First, in step S201, the playing or the outputting to the network is resumed, and the attribute managing unit 2603 removes the “playing paused” attribute from the content and adds the “currently played” attribute in response to a request by the content managing unit 2601 that has been requested by an application program (hereafter referred to simply as an application) or the like. Next, when the transmission of the entire multimedia data of the content is finished in step S202, the processing proceeds to step S203 and the attribute managing unit 2603 removes the “currently played” attribute from the content in response to a request by the content managing unit 2601 that has been requested by an application or the like. The playing observing unit 2606 observes such changing of the attributes of the content by requesting the content managing unit 2601. Alternatively, the playing observing unit 2606 may be notified of the finishing of the content playing by requesting the content managing unit 2601. Upon detecting the end of playing of the content, the playing observing unit 2606 notifies such fact to the deleting condition managing unit 2604, and the processing proceeds to step S204. In step S204, the deleting condition managing unit 2604 judges whether or not the “currently played” attribute or the “playing paused” attribute is added to the content. This is performed by obtaining the attribute by requesting the attribute managing unit 2603 via the content managing unit 2601. Alternatively, the attribute managing unit 2603 may judge whether or not the attribute exists, and notify the deleting condition managing unit 2604 of the result. The processing ends when the “currently played” attribute or the “playing paused” attribute is added (Yes in step S204). When not added (No in step S204), the processing proceeds to step S102, and the same deletion process as described above is performed. It should be noted that the processing in step S204 is effective when the “currently played” attribute or the “playing paused” attribute is added to the content for each client in a multi-client environment in which the content is played by plural clients. Specifically, the content managing unit 2601 manages plural attributes for one content, and the judging unit 2602 judges that deletion is possible for such content when all of the plural attributes do not indicate either one of the “currently played” attribute or the “playing paused” attribute, then proceeds to step S102. Alternatively, the judging unit 2602 judges that deletion is possible for such content when at least one of the plural attributes does not indicate either one of the “currently played” attribute or the “playing paused” attribute, then proceeds to step S102. It should be noted that in the case where only one attribute is managed for one content, after performing the processing in step S203, the multimedia data transmitting apparatus 101 executes the processing in step S102 without performing the processing in step S204.

Furthermore, here, in order to facilitate description, only the processing from the end of playing is described for the description of the processing related to content deletion. However, when playing is paused again, the “playing paused” attribute is added and the processing ends. Furthermore, although the cancellation of the deletion from the user, client device, application, and so on, has not been considered for the sake of simplification, such processing may also be included.

Although described later, it should be noted that an STB and the like which receives a broadcast, can receive an application included in a broadcast signal and execute the received application. For example, in the OpenCable Application Platform (OCAP) standard which is a North American cable television standard, a Java application is transmitted through a broadcast signal and the Java application is executed in a television or STB which receives the broadcast signal. Consequently, the above-described judging unit 2502, judging unit 2602, and deleting condition managing unit 2604 may perform the judgment as to whether or not deletion is possible by making an inquiry to such an application received via a broadcast signal. For example, when the content is a content to which neither the “currently played” nor “playing paused” attribute is added, the judging unit 2502 or the judging unit 2602 may judge whether or not deletion is possible by making an inquiry to the application. Furthermore, the judging unit 2502 or the judging unit 2602 may judge by inquiring to the application, without checking such attributes. Furthermore, the setting of the deleting condition may be performed by the application instead of the judging unit 2602. Such a structure has the effect of allowing the judging condition and the deleting condition for whether or not deletion is possible to be dynamically changeable, and to be controllable by a broadcast operator or service operator.

Hereinafter, the multimedia data transmitting apparatus 101 and the multimedia data receiving apparatus 102 included in the multimedia content communication system 104 shall be described in more detail.

First, the multimedia data transmitting apparatus 101 shall be described.

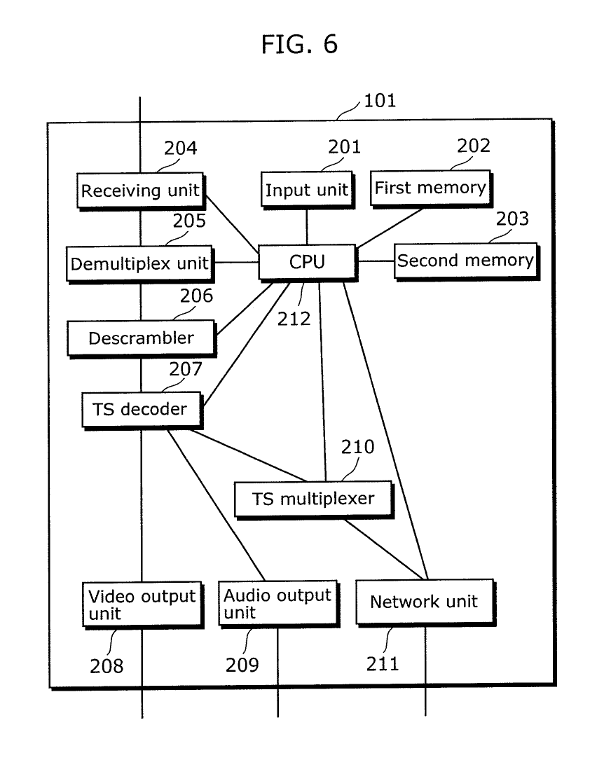

FIG. 6 is a block diagram showing the relationship of constituent elements included in the multimedia data transmitting apparatus 101 in the present embodiment. The multimedia data transmitting apparatus 101 includes an input unit 201, a first memory 202, a second memory 203, a receiving unit 204, a demultiplex unit 205, a descrambler 206, a TS decoder 207, a video output unit 208, an audio output unit 209, a TS multiplexer 210, a network unit 211, and a CPU 212.

The input unit 201 is configured of a front panel, remote control signal receiver, and the like, and accepts an instruction, such as a channel selection, from a user.

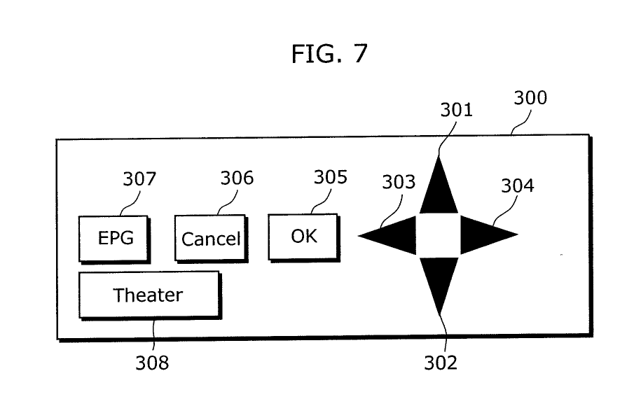

FIG. 7 is a diagram showing an example of the input unit 201 in the case where it is configured of a front panel. The input unit 201 made up of a front panel 300 includes 8 buttons, namely, an up-cursor button 301, a down-cursor button 302, a left-cursor button 303, a right-cursor button 304, an OK button 305, a cancel button 306, an EPG button 307, and a theater button 308. When the user presses down a button, the identifier of such pressed button is notified to the CPU 212.

The first memory 202 is configured of a RAM, or the like, and is used when the CPU 212 temporarily stores data.

The second memory 203 is configured of a device that can hold information even when power is turned off, such as a flash memory, a hard disk, or the like, and stores a program executed by the CPU 212. For the second memory 203, a detachable storage device such as an SD memory card and the like may also be used.

The receiving unit 204 is connected to the cable from a CATV station from which it receives broadcast waves. The receiving unit 204 tunes to the frequency specified by the CPU 212, extracts an MPEG transport stream and passes the extracted MPEG transport stream to the demultiplex unit 205.

The demultiplex unit 205 receives the MPEG transport stream from the receiving unit 204, extracts information specified by the CPU 212 and passes it to the CPU 212. In addition, it passes the MPEG transport stream to the descrambler 206 as it is.

The descrambler 206 descrambles (=decrypts) the scrambled MPEG transport stream provided by the demultiplex unit 205, and passes the descrambled MPEG transport stream to the TS decoder 207. Furthermore, the descrambler 206 also performs the role of extracting information on whether protection is necessary/unnecessary for a TV-program, which is included in the MPEG transport stream, and passing this to the CPU 212. The descrambler 206 may be a module built-into the multimedia data transmitting apparatus 101, and may also be implemented through the CableCARD™ introduced in North American cable receivers. The specifications of CableCARD is described in the CableCARD Interface Specification laid out by the CableLabs in the United States, and thus description is omitted herein.

The TS decoder 207 receives, from the CPU 212, identifiers of audio data, video data, and section data such as PSI/SI information and so on. In addition, the TS decoder 207 extracts, from the descrambled stream received from the descrambler 206, data corresponding to the received identifiers of audio data, video data, and section data such as PSI/SI information and so on, and passes the extracted video data to the video output unit 208, and the audio data to the audio output unit 209. Furthermore, the TS decoder 207 passes both the extracted video data and audio data, as well as the section data, to the TS multiplexer 210.

The video output unit 208, which includes a video output terminal, converts the received video data to video data that complies with the terminal and outputs this. An example of the terminal is a composite cable terminal, and so on.

The audio output unit 209, which includes an audio output terminal, converts the received audio data to audio data that complies with the terminal and outputs this. Examples of the terminal are earphone terminals, a composite cable terminal, and so on.

The TS multiplexer 210 generates an MPEG transport stream from the received video data, audio data, and section data, and passes the MPEG transport stream to the network unit 211. The PSI/SI information can be rewritten as necessary.

The network unit 211, which includes a network interface, converts the data received from the CPU 212 into a signal that is in accordance with the physical media of the network to which the network interface is connected to, and outputs this signal. Furthermore, the network unit 211 receives a signal from the network interface, converts the signal into a packet defined by the IP network, and passes the packet to the CPU 212.

The CPU 212 controls the receiving unit 204, the demultiplex unit 205, the descrambler 206, the TS decoder 207, the TS multiplexer 210, and the network unit 211 by executing a program stored in the second memory 203.

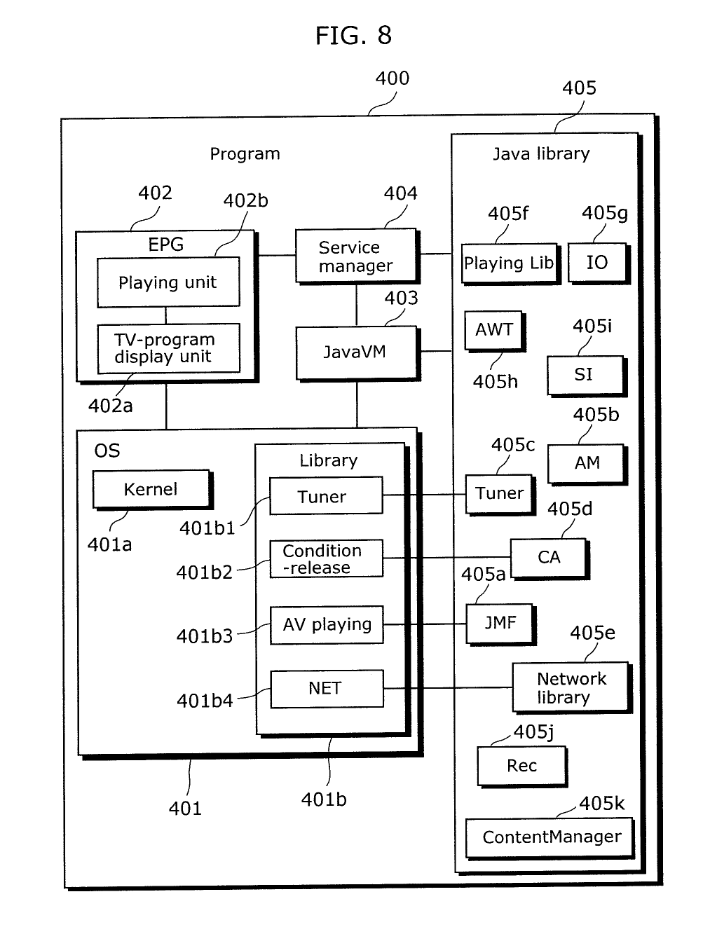

FIG. 8 is a structure diagram showing an example of the program stored in the second memory 203 and executed by the CPU 212.

A program 400 is made up of plural subprograms, and is specifically made up of an OS 401 an EPG 402, a Java VM 403, a service manager 404, and a Java library 405.

The OS 401 is a subprogram activated on the CPU 212 when power to the multimedia data transmitting apparatus 101 is turned on. OS is the acronym for operating system, an example of which is Linux and the like. The OS 401 is a generic name for publicly known technology made up of a kernel 401a for executing another subprogram concurrently, and of a library 401b, and therefore detailed description shall be omitted. In the present embodiment, the kernel 401a of the OS 401 executes the EPG 402 and the VM 403 as subprograms. Furthermore, the library 401b provides these subprograms with plural functions required for controlling the constituent elements held by the multimedia data transmitting apparatus 101.

In the present embodiment, the library 401b includes a tuner 401b1, condition-release 201b2, AV playing 401b3, and NET 401b4, as an example of functions.

The tuner 401b1 receives tuning information including a frequency from other subprograms or a Tuner 405c of the Java library 405, and passes the received tuning information to the receiving unit 204. The receiving unit 204 can perform demodulation based on the provided tuning information, and pass the demodulated data to the demultiplex unit 205. As a result, the other subprograms and the Tuner 405c of the Java library 205 can control the receiving unit 204 through the library 401b.

The condition-release 401b2 receives information from other subprograms or a CA 405d of the Java library 405, and passes the received information to the descrambler 206.

The AV playing 401b3 receives the audio packet ID and video packet ID from the other subprograms or a JMF 405a of the Java library 405. The AV playing 401b3 then provides the received audio packet ID and video packet ID to the TS decoder 207. As a result, the TS decoder 207 performs filtering based on the provided packet IDs, and implements the playing of audio/video.

The NET 401b4 creates packets of a protocol lower than the application layer defined by the IP network, for the data received from the other subprograms or a network library 405e of the Java library 405. Packets of a protocol lower than the application layer refers to, for example, a TCP packet, a UDP packet, an IP packet, and so on. By passing this to the network unit 211, messages and data are transmitted to another device via the network 103. Furthermore, when a message is received from another device via the network 103, the NET 401b4 converts the message to an application layer protocol packet and passes this packet to the other subprograms or the network library 405e of the Java library 405. An application layer protocol refers to, for example, HTTP, Real-time Transport Protocol (RTP), and so on.

The EPG 402 is made up of a TV-program display unit 402a for displaying a list of TV-programs to the user as well as for accepting an input from the user, and a playing unit 402b for selecting channels. Here, EPG is an abbreviation of Electric Program Guide. The EPG 402 is activated by the kernel 401a when power to the multimedia data transmitting apparatus 101 is turned on. Inside the activated EPG 402, the TV-program display unit 402a and the playing unit 402b are activated at the same time. When activated, the TV-program display unit 402a waits for an input from the user through the input unit 201 of the multimedia data transmitting apparatus 101. Here, in the case where the input unit 201 is configured of a front panel as shown in FIG. 7, when the user presses down the EPG button 307 of the input unit 201, the identifier of such EPG button is notified to the CPU 212. The TV-program display unit 402a of the EPG 402 which is a subprogram running on the CPU 212, accepts this identifier, then creates TV-program information display data, and displays this on a monitor 510 using a monitor output unit that is not shown in the figure. The monitor 510 may be included in the multimedia data transmitting apparatus 101, and may also be a television connected to the multimedia data transmitting apparatus 101 by a composite cable, HDMI cable, or the like. The monitor 510 displays the received TV-program information display data.

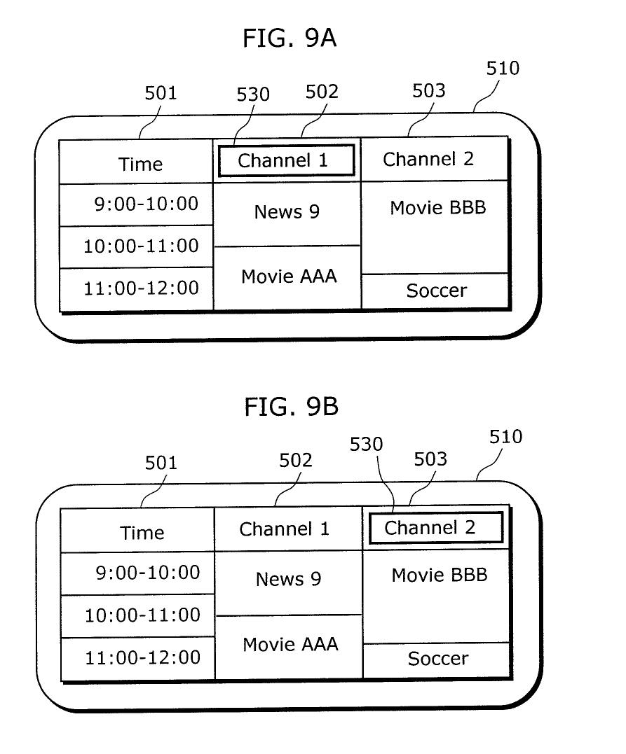

FIG. 9A and FIG. 9B are diagrams showing examples of a TV-program list displayed on the monitor 510. Referring to FIG. 9A, TV-program information is displayed on the monitor 510 in a grid pattern. A column 501 displays time information. A column 502 displays a channel name “Channel 1” and TV-programs to be broadcast during time ranges corresponding to the respective times described in the column 501. The monitor 510 shows that, on “Channel 1”, a TV-program “News 9” is broadcast from 9:00 to 10:30, and “Movie AAA” is broadcast from 10:30 to 12:00. As in the case of the column 502, a column 503 displays a channel name “Channel 2” and TV shows to be broadcast during time ranges corresponding to the respective times described in the column 501. A TV show “Movie BBB” is broadcast from 9:00 to 11:00, and “Soccer” is broadcast from 11:00 to 12:00. 530 is a cursor. The cursor 530 moves at the press of the left-cursor button 303 or the right-cursor button 304 on the front panel 300. When the right-cursor button 304 is pressed down in the state illustrated in FIG. 9A the cursor 530 moves towards the right as shown in FIG. 9B. Furthermore, when the left-cursor button 303 is pressed down in the state illustrated in FIG. 9B the cursor 530 moves towards the left as shown in FIG. 9A.

When the OK button 305 on the front panel 300 is pressed down in the state shown in FIG. 9A, the TV-program display unit 402a notifies the playing unit 402b of the identifier of the “Channel 1”. When the OK button 305 on the front panel 300 is pressed down in the state shown in FIG. 9B, the TV-program display unit 402a notifies the playing unit 402b of the identifier of the “Channel 2”.

Furthermore, through the demultiplex unit 205, the TV-program display unit 402a regularly stores in advance, in the second memory 203, TV-program information to be displayed. Generally, it takes time to obtain TV-program information from the broadcast station. When the EPG button 307 of the input unit 201 is pressed, the TV-program display unit 402a can quickly display a TV-program list by reading the TV-program information display data previously stored in the second memory 203.

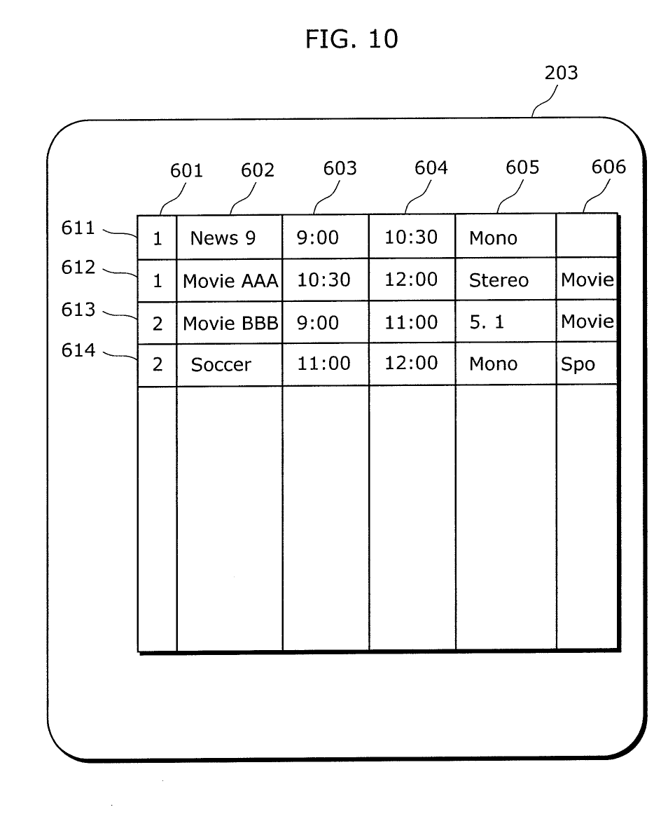

FIG. 10 is a diagram showing an example of TV-program information stored in the second memory 203. The TV-program information is stored in tabular form. A column 601 describes the identifiers of channels. A column 602 describes TV-program names. A column 603 describes the broadcast start times of the TV-programs, and a column 604 describes the broadcast end times. A column 605 describes the sound type of the TV-programs, and indicates mono sound, stereo sound, and 5.1 channel sound as “mono”, “stereo”, and “5.1”, respectively. A column 606 describes the type of the TV-programs. A regular TV-program is described as an empty cell, a movie is described as “movie”, and a sports program is described as “spo”. Each of rows 611 to 614 describes information for one TV-program. In this example, one TV-program information is the set of the channel identifier, TV-program name, broadcast start time, broadcast end time, and TV-program sound type. For example, the row 611 describes a set which includes “1” as the channel identifier, “news 9” as the TV-program name, “9:00” as the broadcast start time, “10:30” as the broadcast end time, “mono” as the sound-type, and “regular” as the TV-program type.

The playing unit 402b plays a channel using the received identifier of the channel. In other words, it plays the video and audio making up the channel. The relationship between channel identifiers and channels is pre-stored in the second memory 203 as channel information.

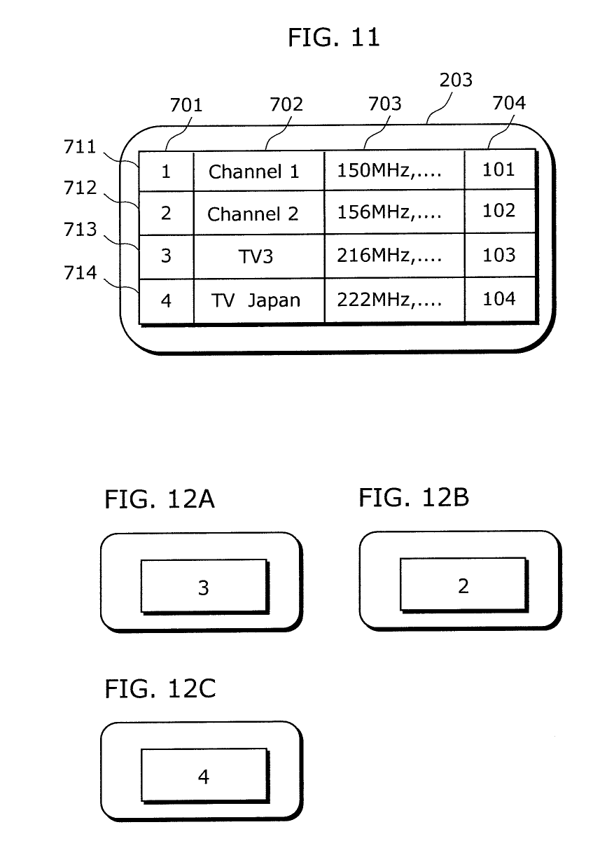

FIG. 11 is a diagram showing an example of the channel information stored in the second memory 203. The channel information is stored in tabular form. A column 701 describes the identifiers of channels. A column 702 describes channel names. A column 703 describes tuning information. Here, the tuning information are values to be provided to the receiving unit 204, such as frequency, transmission rate, and coding ratio. A column 704 describes program numbers. Program numbers are numbers used to identify PMTs defined by the MPEG-2 standard. A description about PMT is given later. Each of rows 711 to 714 indicates a set of the identifier, channel name, and tuning information of each channel. The row 711 describes a set that includes “1” as an identifier, “Channel 1” as a channel name, a frequency of “150 MHz” as tuning information, and “101” as a program number. The playing unit 402b passes the received identifier of the channel directly to the service manager 404 in order to play the channel.

Moreover, when the user presses down the up-cursor button 301 or the down-cursor button 302 on the front panel 300 while the playing is taking place, the playing unit 402b receives a notification about such pressing from the input unit 201 through the CPU 212, and changes the channel being played accordingly. When the up-cursor button 301 is pressed down, a channel having the next lower channel identifier to that of the currently-played channel is played, and when the down-cursor is pressed 302 is pressed down, a channel having the next higher channel identifier to that of the currently-played channel is played. First, the playing unit 402b stores, in the second memory 203, the identifier of the channel that is currently played.

FIG. 12A, FIG. 12B, and FIG. 12C are diagrams showing examples of channel identifiers stored in the second memory 203. FIG. 12A shows that an identifier “3” is stored, and by referring to FIG. 11, it is shown that a channel having the channel name “TV 3” is currently played. When the user presses down the up-cursor button 301 in a state illustrated in FIG. 12A, the playing unit 402b refers to the channel information shown in FIG. 11, and passes the identifier “2” of a channel with the channel name of “Channel 2” to the service manager 404 in order to switch playing to the channel with the channel name of “Channel 2” which is the channel having an identifier that is one value lower than that of the channel currently played. At the same time, the playing unit 402b rewrites the identifier stored in the second memory 203 to the channel identifier “2”. FIG. 12B shows the state in which the channel identifier has been rewritten. Furthermore, when the user presses down the down-cursor button 302 in a state illustrated in FIG. 12A, the playing unit 402b refers to the channel information shown in FIG. 11, and passes the identifier “4” of a channel having the channel name of “TV Japan” to the service manager 404 in order to switch playing to the channel having the channel name of “TV Japan” which is the channel having an identifier which is one value higher than that of channel currently played. At the same time, the playing unit 402b rewrites the identifier stored in the second memory 203 to the channel identifier “4”. FIG. 12C shows the state in which the channel identifier has been rewritten. The channel identifier is saved, even when power to the multimedia data transmitting apparatus 101 is cut-off, since it is stored in the second memory 203.

In addition, upon being activated when power to the multimedia data transmitting apparatus 101 is turned on, the playing unit 402b reads the channel identifier stored in the second memory 203. Then, the playing unit 402b passes such channel identifier to the service manager. With this, when power is turned on, the multimedia data transmitting apparatus 101 is able to start the playing of the last channel that was being played at the time of its previous operation.

The Java VM 403 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Some Java virtual machines pass the byte code to the CPU 212 after translating the byte code into an execution format which can be interpreted by the CPU 212, and executes it. The Java VM 403 is activated, with a Java program to be executed being specified by the kernel 401a. In the present embodiment, the kernel 401a specifies the service manager 404 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 404, which is a Java program written in the Java language, is sequentially executed by the Java VM 403. It is possible for the service manager 404 to call or be called by another subprogram not written in the Java language, through the Java Native Interface (JNI). The JNI is also described in many publications such as in the book “Java Native Interface” and so on. Here, such details are omitted.

First the process in the case of receiving a digital broadcast and playing the received multimedia data shall be described.

The service manager 404 accepts the identifier of a channel from the playing unit 402b, through the JNI.

The service manager 404 first passes the identifier of the channel to the Tuner 405c in the Java library 405, and requests for tuning. The Tuner 405c refers to the channel information stored in the second memory 203, and obtains the tuning information. Now, when the service manager 404 passes the identifier “2” of the channel to the Tuner 405c, the Tuner 405c refers to the column 712 shown in FIG. 11, and obtains the corresponding tuning information “156 MHz”. The Tuner 405c passes the tuning information to the receiving unit 204 through tuner 401b1 of the library 401b of the OS 401. The receiving unit 204 performs demodulation on the signal transmitted from the broadcast station, based on the provided tuning information, and passes the result to the demultiplex unit 205.

The service manager 404 requests the CA 405d in the Java library 405 to perform descrambling. The CA 405d provides the descrambler 206 with information required for descrambling, through the condition-release 401b2 of the library 401b in the OS 401. On the basis of such provided information, the descrambler 206 descrambles the signal provided by the receiving unit 204, and passes the result to the TS decoder 207.

The service manager 404 provides the identifier of the channel to a JMF 405a in the Java library 405, and requests for the playing of the video and audio.

First, the JMF 405a obtains, from a PAT and a PMT, packet IDs used to specify the video and audio to be played. PAT and PMT are tables stipulated by the MPEG-2 standard that show the TV-program line-up included in an MPEG transport stream. PAT and PMT are embedded in the payloads of packets included in an MPEG transport stream, and are sent together with audio and video. Refer to the Specification for details. Here, only the outline shall be described. PAT, which is an abbreviation of Program Association Table, is stored and sent in packets with the packet ID “0”. In order to obtain the PAT, the JMF 405a specifies, to the demultiplex unit 205, the packet ID “0”, through the library 401b of the OS 401. The demultiplex unit 205 performs filtering based on the packet ID “0” and, by passing the result to the CPU 212, the JMF 405a collects the PAT packets.

FIG. 13 is a diagram which schematically shows an example of information of the collected PAT. A column 901 describes program numbers. A column 902 describes packet IDs. The packet IDs shown in the column 902 are used to obtain the PMT. Each of rows 911 to 913 is a pair of the program number of a channel and a corresponding packet ID. Here, three channels are defined. The row 911 defines a pair of the program number “101” and the packet ID “501”. Now, when the channel identifier provided to the JMF 405a is “2”, the JMF 405a refers to the column 912 in FIG. 13, so as to obtain the corresponding program number “102”, and then refers to the column 912 in the PAT shown in FIG. 13, so as to obtain the packet ID “502” corresponding to the program number “102”. PMT, which is an abbreviation of Program Map Table, is stored and sent in packets of the packet ID stipulated in the PAT. In order to obtain the PMT, the JMF 405a specifies the packet ID to the demultiplex unit 205, through the library 401b of the OS 401. Here, it is assumed that the packet ID specified is “502”. The demultiplex unit 205 performs filtering based on the packet ID “502” and, by passing the result to the CPU 212, the JMF 405a collects the PMT packets.

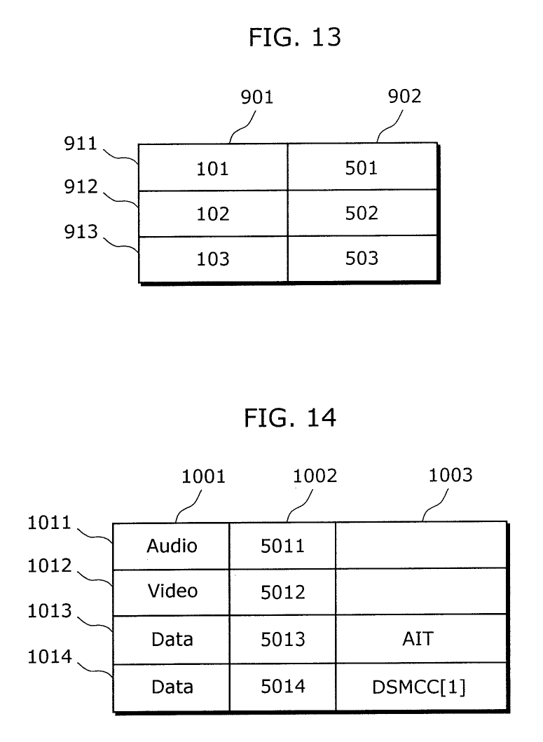

FIG. 14 is a diagram which schematically shows an example of information of the collected PMT. A column 1001 describes stream types. A column 1002 describes packet IDs. Information specified in the respective stream types is stored and sent in the payloads of packets with the packet IDs specified in the column 1002. A column 1003 describes supplementary information. Each of columns 1011 to 1014 is a pair of a packet ID and the type of information being transmitted, which is known as an elementary stream. The column 1011, which is a pair of the stream type “audio” and the packet ID “5011”, indicates that audio data is stored in the payload of the packet with the packet ID “5011”. The JMF 405a obtains, from the PMT, the packet IDs of the video and audio to be played. Referring to FIG. 14, the JMF 405a obtains the audio packet ID “5011” from the row 1011, and the video packet ID “5012” from the row 1012.

Next, the JMF 405a passes the obtained audio packet ID and video packet ID to the AV playing 401b3 of the library 401b of the OS 401. Upon receiving this, the AV playing 401b3 provides the received audio packet ID and video packet ID to the TS decoder 207. The TS decoder 207 performs filtering based on such provided packet IDs. Here, the packet with the packet ID “5011” is passed to the audio output unit 209, and the packet with the packet ID “5012” is passed to the video output unit 208. The audio output unit 209 converts (for example, digital-analog conversion) the provided packet, as necessary, and outputs this. The video output unit 208 converts (for example, digital-analog conversion) the provided packet, as necessary, and outputs this.

Finally, the service manager 404 provides the channel identifier to an AM 405b in the Java library 405, and requests for data broadcast playing. Here, data broadcast playing refers to extracting a Java program included in the MPEG transport stream, and having it executed by the Java VM 403. As a method of encapsulating a Java program in an MPEG transport stream, a method referred to as DSMCC, which is described in the MPEG Standard ISO/IEC 13818-6, is used. Here, detailed description of DSMCC shall be omitted. The DSMCC defines a method of encoding the file system made up of directories and files used by a computer in the packets of an MPEG transport stream. Furthermore, information about the Java program to be executed is embedded and transmitted in packets in the MPEG transport stream in a format referred to as AIT. AIT is an abbreviation of Application Information Table defined in the 10th chapter of the DVB-MHP Standard (formally as, ETS TS 101 812 DVB-MHP Specification V1.0.2).

First, in order to obtain the AIT, the AM 405b obtains the PAT and PMT as in the case of the JMF 405a, so as to obtain the packet ID of the packet that stores the AIT. Now, when “2” is the identifier of the provided channel and the PAT shown in FIG. 13 and the PMT shown in FIG. 14 are being transmitted, the AM 405b obtains the PMT shown in FIG. 14 according to the same procedure followed by the JMF 405a. The AM 405b extracts, from the PMT, the packet ID of the elementary stream having a stream type of “Data” and which has “AIT” as supplementary information. Referring to FIG. 14, the elementary stream in the row 1013 corresponds to such description, and therefore the AM 405b obtains the packet ID “5013”.

The AM 405b provides the packet ID of the AIT to the demultiplex unit 205, through the library 401b of the OS 401. The demultiplex unit 205 performs filtering based on such provided packet ID, and passes the result to the CPU 212. As a result, the AM 405b can collect the packets of AIT.

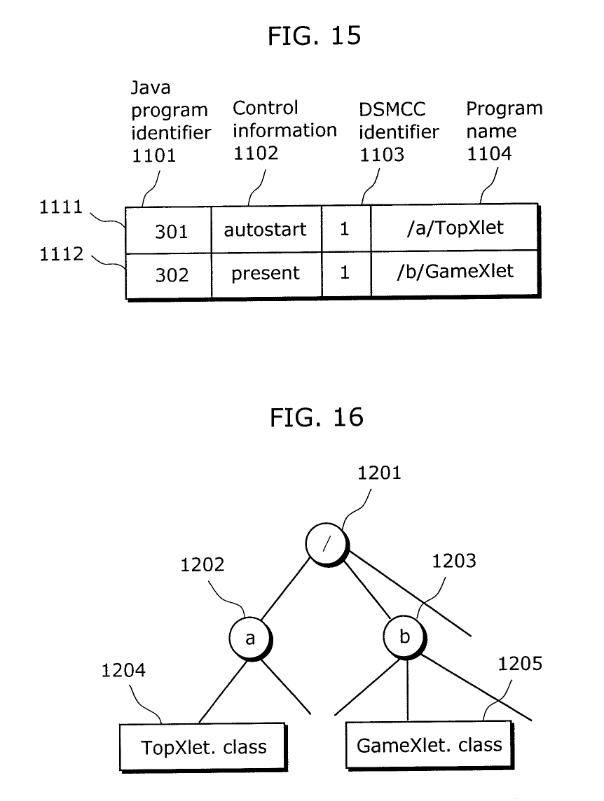

FIG. 15 is a chart which schematically shows an example of information of the collected AIT. A column 1101 describes the identifiers of Java programs. A column 1102 describes control information of the Java programs. The control information includes “autostart”, “present”, and “kill”. “autostart” means that the multimedia data transmitting apparatus 101 automatically executes the program immediately. “present” means that the program is not executed automatically. “kill” means that the program is to be terminated. A column 1103 describes DSMCC identifiers for extracting packet IDs including a Java program in the DSMCC format. A column 1104 describes program names of the Java programs. Each of rows 1111 and 1112 is a set of information about a Java program. The Java program defined in the row 1111 is a set of an identifier “301”, control information “autostart”, a DSMCC identifier “1”, and a program name “a/TopXlet”. The Java program defined in the row 1112 is a set of an identifier “302”, control information “present”, a DSMCC identifier “1”, and a program name “b/GameXlet”. Here, the two Java programs have the same DSMCC identifier which indicates that two Java programs are included within a single file system encoded in the DSMCC format. Here, only four items of information are stipulated for the respective Java programs, but more items of information are specified in actuality. Refer to the DVB-MHP standard for details.

The AM 405b finds the “autostart” Java program from within the AIT, and extracts the corresponding DSMCC identifier and Java program name. Referring to FIG. 15, the AM 405b extracts the Java program in the row 1111, and obtains the DSMCC identifier “1” and the Java program name “a/TopXlet”.

Next, using the DSMCC identifier obtained from the AIT, the AM 405b obtains, from the PMT, the packet ID of packets that store Java programs in the DSMCC format. More specifically, the AM 405b obtains, from within the PMT, the packet ID of the elementary stream whose stream type is “Data” and having a matching DSMCC identifier in the supplementary information.

Now, assuming that such DSMCC identifier is “1” and the PMT is that shown in FIG. 14, the elementary stream in the row 1014 matches, and the packet ID “5014” is to be extracted.

The AM 405b specifies the packet ID of the packet in which data is embedded in the DSMC format, to the demultiplex unit 205, through the library 401b of the OS 401. Here, the packet ID “5014” is provided. The demultiplex unit 205 performs filtering based on such provided packet ID, and passes the result to the CPU 212. As a result, the AM 405b can collect the required packets. The AM 405b reconstructs the file system from the collected packets, according to the DSMCC format, and stores this in the first memory 202 or the second memory 203. Extracting the data of a file system, and the like, and storing this in the first memory 202 or the second memory 203 shall hereafter be referred to as download.

FIG. 16 shows an example of a downloaded file system. In the figure, a circle denotes a directory and a square denotes a file. 1201 denotes a root directory, 1202 denotes a directory “a”, 1203 denotes a directory “b”, 1204 denotes a file “TopXlet.class”, and 1205 denotes a file “GameXlet.class”.

Here, although an example of downloading a file system from an MPEG transport stream is described, the OCAP specification also stipulates downloading using an IP network, and so on. Furthermore, a method for identifying the location of a file system using information referred to as XAIT, instead of AIT, and downloading the file system is also stipulated.

Next, the AM 405 passes, to the Java VM 403, the Java program to be executed from within the file system downloaded into the first memory 202 or the second memory 203. Here, when the name of the Java program to be executed is “a/TopXlet”, the file “a/TopXlet.class”, having “.class” added to the end of the Java program name, is the file to be executed. “/” is a division of a directory and file name and, by referring to FIG. 16, the file 1204 is the Java program to be executed. Next, the AM 405b passes the file 1204 to the Java VM 403. The Java VM 403 executes the Java program passed to it.

Upon receiving an identifier of an other channel, the service manager 404 terminates the execution, through the respective libraries included in the Java library 405, of the video/audio and Java program currently played likewise through the respective libraries included in the Java library 405, and performs the playing of video/audio and execution of a Java program based on the newly received channel identifier.

Furthermore, the service manager 404 also includes a function for receiving the identifier of a channel from a Java program executed on the Java VM 403, aside from the playing unit 402b. Specifically, it provides the Java language class and its methods for obtaining the identifier of the channel. Upon receiving an identifier of a channel, the service manager 404 terminates the execution, though the respective libraries included in the Java library 405, of the video/audio and Java program currently played likewise through the respective libraries included in the Java library 405, and subsequently performs the playing of new video/audio and the execution of a Java program based on the newly received channel identifier.

Next, the operation of receiving a digital broadcast and storing the multimedia data (content) thereof in the second memory 203, in the multimedia data transmitting apparatus 101 shall be described.

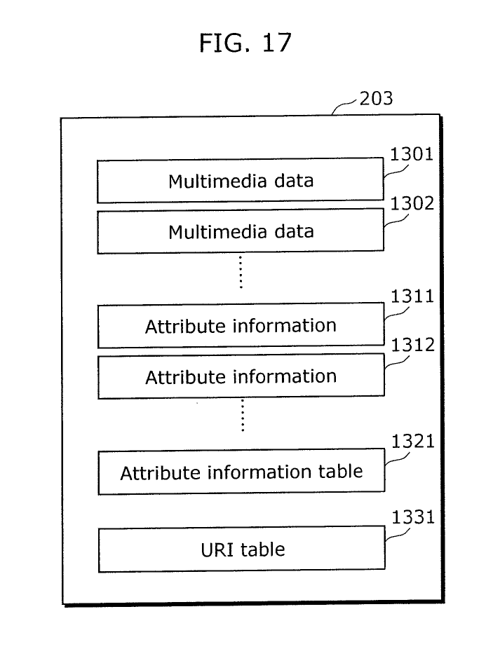

FIG. 17 is a diagram showing an example of the form of the storing of multimedia data into the second memory 203 by the multimedia data transmitting apparatus 101. The multimedia data transmitting apparatus 101 stores, in the second memory 203, multimedia data 1301, 1302, . . . and their attribute information 1311, 1312, . . . , an attribute information table 1321, and a URI table 1331. The multimedia data 1301, 1302, . . . are multimedia data encoded in the MPEG2-TS format. The attribute information 1311, 1312, . . . are additional information such as the title of each multimedia data. Here, the attribute information 1311 describes attribute information of the multimedia data 1301, and the attribute information 1312 describes attribute information of the multimedia data 1302.

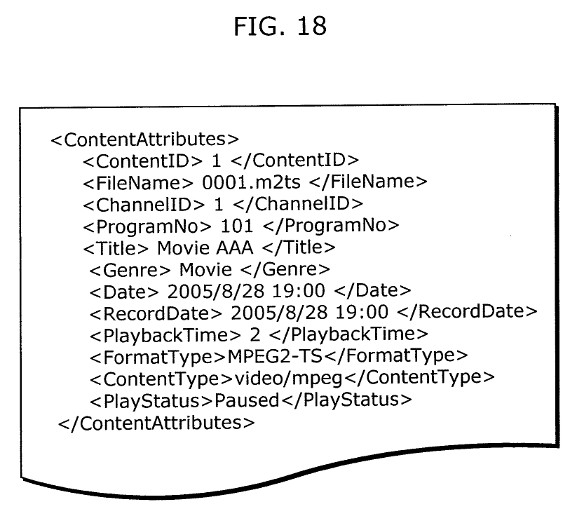

FIG. 18 is a diagram showing an example of attribute information in the present embodiment. In the present embodiment, attribute information is represented by the text defined with the Extensible Markup Language (XML). In FIG. 18, a ContentID element describes the identifier of a content (multimedia data); a FileName element describes the filename of the multimedia data; a ChannelID element describes an identifier of a channel on which the TV-program (content or multimedia data) was broadcast, as shown in column 601 in FIG. 10; a ProgramNo element describes a program number for retrieving the PMT, as shown in column 704 in FIG. 11; a Title element describes the TV-program name as shown in column 602 in FIG. 10; a Genre element describes the type of the program, as shown in column 606 in FIG. 10; a Date element describes the date and time at which the TV-program was broadcast; a RecordDate element describes the date and time at which the TV-program was recorded; a PlaybackTime element describes the number of times the multimedia data has been played or outputted to the network 103; a FormatType element describes the type of the media format of the content; and a ContentType element describes the Content-Type assigned to the media format of the content by the Internet Assigned Numbers Authority (IANA). Furthermore, a PlayStatus element describes the “currently played” or “playing paused” attribute, and denotes “currently played” when its content is “Playing” and denotes “playing paused” when it is “Paused”. Note that the attribute information is not limited to the configuration by using XML, and the information can be recorded in the other formats such as binary data.

The attribute information table 1321 is a correspondence chart for the identifier of the content, the file on which the multimedia data of the content indicated by the identifier is recorded, and the file on which the attribute information is recorded.

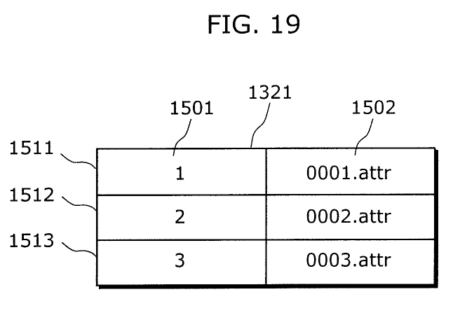

FIG. 19 is a diagram showing an example of the attribute information table 1321. In FIG. 19, a column 1501 describes the content identifiers, and a column 1502 describes file names of the attribute information. Rows 1511 to 1513 are pairs of the content identifier and the file name of the corresponding attribute information. From column 1511, it can be read that the attribute information of the content for identifier 1 is recorded in the file 0001.attr.

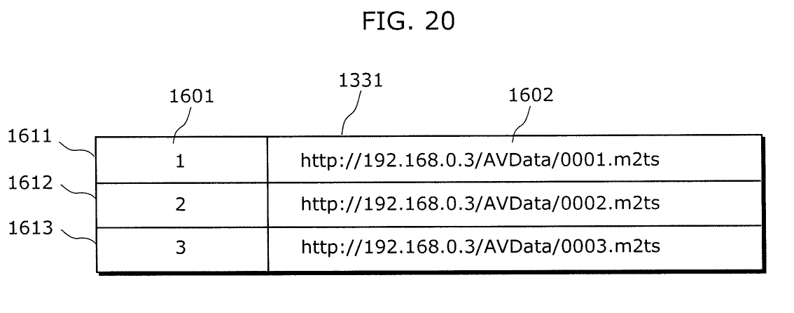

FIG. 20 is a diagram showing an example of the structure of the URI table 1331. In FIG. 20, a column 1601 describes the identifiers of respective contents, and a column 1602 describes URIs for accessing the respective contents. Rows 1611 to 1613 show pairs of the identifier and URI of respective contents. For example, row 1611 indicates that the URI of the content for identifier 1 is http://192.168.0.3/AVData/0001.m2ts.

Hereinafter, the storing process shall be described. First, the operation up to descrambling is the same as in the case of the previously described playing. Next, the service manager 404 requests, the CA 405d, for the obtainment of protection required/not required information concerning the multimedia data and, in the case where protection is required, information on the kind of protection. This information shall be called protection information. The CA 405d receives the protection information of the multimedia data from the descrambler 206, and passes the received protection information to the service manager 404. Next, the service manager 404 judges, referring to the protection information passed on to it, whether or not the multimedia data can be stored. Only in cases where storing is allowed does the service manager 404 provide the channel identifier and request the storing of the multimedia data, and the generating of the attribute information of the multimedia data to a Content Manager 405k inside the Java library 405. It should be noted that, as shown in FIG. 2, the Content Manager 405k is configured of the content managing unit 2501 and the judging unit 2502. Alternatively, as shown in FIG. 4, the Content Manager 405k is configured of the content managing unit 2601, the judging unit 2602, and the deleting condition managing unit 2604. The Content Manager 405k first requests the storing of the multimedia data to a Rec 405j inside the Java library 405. The Rec 405j first obtains the PAT and PMT in the same manner as the JMF 405a and AM 405b, and obtains packet IDs for the video data, audio data, and respective section data relating to the TV-program to be stored. Now, when “2” is the identifier of the provided channel and the PAT shown in FIG. 13 and the PMT shown in FIG. 14 are being transmitted, the Rec 405j obtains the PMT shown in FIG. 14 according to the same procedure followed by the JMF 405a. The data to be stored are all the data described in the PMT in FIG. 14.

The Rec 405j provides these packet IDs to the TS decoder 207 through the library 401b of the OS 401 and causes these to be outputted to the TS multiplexer 210. The TS decoder 207 performs filtering based on such provided packet IDs, and passes the result to the TS multiplexer 210. Each section data is assigned the respective version number, and it should be noted that the TS decoder 207 may output the same type of data only once for each version number and the rest are filtered.

Furthermore, the Rec 405j provides, to the TS multiplexer 210 through the library 401b of the OS 401, the number of types of data to be transmitted, and causes the construction of an MPEG transport stream from the data passed on from the TS decoder 207. The constructed MPEG transport stream is passed on to the CPU 212.

In addition, the Rec 405j writes, into the second memory 203, the MPEG transport stream received by the CPU 212 from the TS multiplexer 210, by requesting an IO 405g inside the Java library 405.

Next, by requesting the IO 405g, the Content Manager 405k reads the TV-program information corresponding to the stored multimedia data from among the TV-program information shown in FIG. 10 and stored in the second memory 203. In addition, the Content Manager 405k generates the identifier of the stored multimedia data. This identifier allows the unique identification of the multimedia data in the multimedia data transmitting apparatus 101. In addition, the Content Manager 405k receives, from the Rec 405j, the file name under which the multimedia data is stored. In addition, the Content Manager 405k creates attribute information from the obtained TV-program information, identifier of the multimedia data, and the file name under which the multimedia data is stored, and writes the attribute information into the second memory 203 by requesting the IO 405g. In addition, the Content Manager 405k updates the attribute information table by reading the attribute information table by requesting the IO 405g, and updating its contents, and writing the updated attribute information table into the second memory 203 by requesting the IO 405g.

Note that although, in the present embodiment, the descrambler 206 obtains the protection information of the content and passes this to the CPU 212, it is also possible to have the demultiplex unit 205 or the TS decoder 207 obtain the protection information and pass this to the CPU 212. Alternatively, it is also possible to equip a unit which communicates with the broadcast station 105 and obtain the protection information separately from the broadcast station 105. Alternatively, the protection information may be broadcast by being embedded in the PMT, and then extracted from the PMT by the TS decoder 207 or the CPU 212.

Furthermore, although the MPEG transport stream that is written into the second memory 203 is the MPEG transport stream constructed by the TS multiplexer 210, such MPEG transport stream may be one that is constructed by the TS decoder 207 extracting the TS packets having the packet ID provided to it and passing the extracted TS packets to the TS multiplexer 210, and by the TS multiplexer 210 simply arranging the TS packets passed on to it. Such an MPEG transport stream is referred to as a Partial TS according to DVB and ARIB definitions. It should be noted that it is preferable that the SI information be appropriately rewritten at this time.

Furthermore, the MPEG transport stream that is written into the second memory 203 may be encrypted prior to the writing. In particular, when protection is required such as in the case where the content is a paid content, encryption using an encryption algorithm having appropriate strength is preferable.

Furthermore, in the present embodiment, through the storing of the multimedia data and attribute information in the second memory 203 by the content managing units 2501 or 2601 of the Content Manager 405k, the content managing units 2501 or 2601 hold the content of such multimedia data and the attribute information thereof.

Next, the processing in the case of outputting the multimedia data of a received digital broadcast from the network unit 211 shall be described.

First, the network library 405e inside the Java library 405 receives a request from a terminal connected to the network 103, and provides the identifier of the channel being requested, to the service manager 404. The service manager 404 provides the received channel identifier to the Tuner 405c and requests tuning, then requests descrambling to the CA 405d, and returns the processing to the network library 405e.

The network library 405e then controls the TS decoder 207 and the TS multiplexer 210, and creates an MPEG transport stream from the video data, audio data, and section data of the TV-program, in the same manner as the Rec 405j described above.

In addition, the network library 405e provides the address of the transmission destination to the NET 401b4 of the library 401b of the OS 401. Next, the network library 405e converts the MPEG transport stream received from the TS multiplexer 210 into a format that is in accordance with the protocol of the application layer to be transmitted, and sequentially passes the converted MPEG transport stream to the NET 401b4. An application layer protocol refers to, for example, HTTP, RTP, and so on. With this, the NET 401b4 refers to the transmission destination address, and converts the data passed on to it into IP network packets and passes these to the network unit 211. The network unit 211 converts the data passed on to it into a signal that is in accordance with the physical media of the network connected to, and outputs this signal.

Note that the network library 405e may encrypt data and transmit the encrypted data.

Next, the processing when playing the multimedia data stored in the second memory 203 shall be described. First, the service manager 404 receives the identifier and playing start position of the content. Although a temporal position called media time which assumes 0 as the beginning of the multimedia data is generally used for the playing start position, others may be used as long as the start position can be uniquely specified. Next, the service manager 404 obtains the file name under which the multimedia data of the content for the identifier is stored, and the identifier of the channel or the program number, by requesting the Content Manager 405k inside the Java library 405. When requested, the Content Manager 405k first reads the attribute information table 1321 from the second memory 203 by requesting the IO 405g, and searches for the file in which the attribute information of the content for the identifier is recorded. In the attribute information table in FIG. 19, when the content identifier is 1, the file is 0001.attr. Next, the requested Content Manager 405k reads the file in which the attribute information is recorded, from the second memory 203, by requesting the IO 405g. The Content Manager 405k obtains the file name under which the multimedia data of the content is recorded, from the read attribute information. In the case of the attribute information in FIG. 18, 0001.m2ts corresponds to the file name. Furthermore, the Content Manager 405k obtains the identifier of the channel and the program number from the read attribute information. In the case of the attribute information in FIG. 18, the identifier of the channel is 1 and the program number is 101. The Content Manager 405k returns such information to the service manager 404.

In addition, by requesting the IO 405g, the service manager 404 reads the MPEG transport stream from the file of the multimedia data, starting from the specified playing start position. Although there is a need to convert the playing start position to a byte position when the playing start position is provided by media time, the conversion can be carried out by using a media time and byte position correspondence chart which is not illustrated. Such a correspondence chart is assumed to be generated at the time the multimedia data is stored. The IO 405g, to which reading has been requested, reads the data through the library 401b of the OS 401, and passes the data to the CPU 212. The service manager 404 passes the read MPEG transport stream to the CPU 212. Furthermore, the service manager 404 passes the received MPEG transport stream to the demultiplex unit 205, through the library 401b of the OS 401.

In addition, the service manager 404 requests the CA 405d in the Java library 405 so that the descrambler 206 lets the data through without descrambling. The CA 405d provides the descrambler 206 with information, through the condition-release 401b2 of the library 401b in the OS 401. With this, the descrambler 206 passes the data received from the demultiplex unit 205, as-is, to the TS decoder 207.

In addition, the service manager 404 provides the identifier of the channel or program number received from the Content Manager 405k to the JMF 405a inside the Java library 405, and requests for playing. Hereafter, the playing of video data and audio data is performed according to the same process as in the previously described case of a content received from a broadcast.

In addition, the service manager 404 changes the attribute information of the multimedia data by requesting the Content Manager 405k. When requested, the Content Manager 405k first reads the file in which the attribute information of the multimedia data is recorded, from the second memory 203, by requesting the IO 405g. The Content Manager 405k adds the “currently played” attribute to the read attribute information and, by requesting the IO 405g again, updates the attribute information in the second memory 203.

In addition, the service manager 404 provides the channel identifier or the program number to the AM 405b inside the Java library 405, and requests for data broadcast playing. Hereafter, the data broadcast playing can be performed according to the same process as in the previously described case of a content received from a broadcast.

It should be noted that although, in the present embodiment, the service manager 404 receives the playing start position, it is also possible that the service manager 404 is merely requested to carry out the resumption of playing, and the service manager 404 performs the processing by obtaining the playing pause position of the multimedia data stored in the second memory 203 and the like.

Next, the processing when the multimedia data is played until the end shall be described. First, the service manager 404 causes the playing to end by requesting the JMF 405a. In addition, the service manager 404 causes the data broadcast playing to end by requesting the AM 405b. In addition, the service manager 404 changes the attribute of the multimedia data by requesting the Content Manager 405k. When requested, the Content Manager 405k first reads the file in which the attribute information of the multimedia data is recorded, from the second memory 203, by requesting the IO 405g. The Content Manager 405k removes the “currently played” attribute from the read attribute information and, by requesting the IO 405g again, updates the attribute information in the second memory 203.

Next, the processing when the playing of the content is paused by the user shall be described. This is when a “playing stop” button on the remote control or front panel is pressed. First, the service manager 404 causes the pausing of playing by requesting the JMF 405a. In addition, the service manager 404 causes the pausing of the data broadcast playing by requesting the AM 405b. In addition, the service manager 404 stops the reading of the MPEG transport stream by requesting the IO 405g. In addition, the service manager 404 makes an inquiry to the IO 405g or the JMF 405a about the position at which the playing of the multimedia data was paused. The position at which the playing of the multimedia data was paused can be represented by a byte position in the multimedia data or the temporal position assuming 0 as the beginning of the multimedia data. In addition, the service manager 404 provides the position at which the playing of the multimedia data was paused to the Content Manager 405k and requests the changing of the attribute of the multimedia data.

When requested, the Content Manager 405k reads the file in which the attribute information of the multimedia data is recorded, from the second memory 203, by requesting the IO 405g. In addition, the Content Manager 405k judges, according to the received playing pause position, whether the playing of the multimedia data has ended or it is a playing pause in which a continuation shall be played thereafter. This is judged by whether or not the entire data of the multimedia data has been read or played. Alternatively, it may be judged by whether or not the multimedia data has been read or played up to a specified position in the multimedia data. When it is judged that playing has ended, the Content Manager 405k removes the “currently played” attribute from the read attribute information, and updates the attribute memory in the second memory 203 by requesting the IO 405g, in the same manner as described above. When it is judged that playing has been paused, the Content Manager 405k removes the “currently played” attribute from the read attribute information and further adds the “playing paused” attribute, and updates the attribute memory in the second memory 203 by requesting the IO 405g. It should be noted that, instead of being performed by the Content Manager 405k, the judgment for whether playing has ended or playing has been paused may be performed by the Java application, with the Content Manager 405k making an inquiry to the Java application. Furthermore, when it is judged that playing has been paused, the pause position may also be passed to the Java application or stored in the second memory 203. Furthermore, when storing the playing pause position in the second memory 203, the playing pause position may be added to the attribute information.

Next, the process of transmitting, from among the multimedia data stored in the second memory 203, multimedia data requested by a terminal (request source terminal) connected to the network 103 to the request-source terminal shall be described.

First, the network library 405e parses the request message transmitted from the request-source terminal, and obtains the URI of the requested content. This is carried out through the network library 405e analyzing the activated server module, the port number of the server to which the terminal has connected with, and the request message. Next, the network library 405e reads the URI table 1331 by requesting the IO 405g. The identifier of the requested content is obtained from the read URI table 1331 and the URI obtained from the request message. For example, in the URI table shown in FIG. 20, when the requested URI is http://192.168.0.3/AVData/0001.m2ts, a content identifier 1 is obtained from the content in row 1611.

Next, the network library 405e requests the obtaining of the attribute information of the content identifier to the Content Manager 405k. When requested, the Content Manager 405k first reads the attribute table 1321 by requesting the IO 405g. Subsequently, the file name of the attribute information file of the content is obtained based on the identifier of the requested content. For example, in the attribute information table 1321 shown in FIG. 19, it can be seen that the attribute information file of the content of identifier 1 is 0001.attr. Next, by requesting the IO 405g, the Content Manager 405k reads the attribute information of the obtained file name and passes it to the network library 405e.

The network library 405e receiving the attribute information obtains the file name under which the multimedia data of the content is stored, from the FileName element among the contents of the attribute information. For example, in the case of the attribute information file shown in FIG. 18, it can be seen that the file name of the multimedia data is 0001.m2ts.

Next, the network library 405e verifies the presence of the multimedia data of the obtained file name by requesting the IO 405g. When not present, the network library 405e generates an error message, transmits this to the request-source terminal, and ends the process. When present, the network library 405e collects information, such as information of the attribute information file and the file size which is obtainable by requesting the IO 405g, generates the header of a response message, and transmits the header to the request-source terminal. Next, by requesting the IO 405g, the network library 405e sequentially reads the multimedia data and transmits the read data to the request-source terminal.

Furthermore, when the transmission range is specified by the request-source terminal, the network library 405e reads such portion of the multimedia data, collects information such as the data size of the corresponding portion and generates a header of a response message, and transmits this to the request-source terminal, by requesting the IO 405g. Next, the network library 405e transmits, to the request-source terminal, the corresponding portion of the multimedia data that has been read.

Furthermore, when the playing speed is specified by the request-source terminal, the network library 405e generates and transmits a header of a response message, then, in accordance with the specified playing speed, selects plural sections of the multimedia data, and reads and transmits the corresponding portion of the multimedia data to the request-source terminal by requesting the IO 405g.

In addition, the network library 405e requests the changing of the attribute information of the content identifier to the Content Manager 405k. When requested, the Content Manager 405k first reads the attribute information file of the multimedia data from the second memory 203 by requesting the IO 405g. The Content Manager 405k adds the “currently played” attribute to the read attribute information and, by requesting the IO 405g again, updates the attribute information.

Next, the processing when the multimedia data is transmitted until the end shall be described. At this time, the network library 405e requests the changing of the attribute of the multimedia data to the Content Manager 405k. When requested, the Content Manager 405k first reads the attribute information file of the multimedia data from the second memory 203 by requesting the IO 405g. The Content Manager 405k removes the “currently played” attribute from the read attribute information and, by requesting the IO 405g again, updates the attribute information in the second memory 203.

Next, the processing when the transmission of the multimedia data is paused shall be described. This refers to the case where the HTTP session through which the multimedia data is communicated is terminated. First, the network library 405e stops the reading of the multimedia data by requesting the IO 405g. In addition, the network library 405e provides the position, in the multimedia data, of the last-transmitted data to the Content Manager 405k and requests the updating of the attribute of the multimedia data. When requested, the Content Manager 405k first reads the attribute information file of the multimedia data from the second memory 203 by requesting the IO 405g. Next the Content Manager 405k judges, based on the received playing transmission stop position, whether the transmission of the multimedia data has ended or it is a playing pause in which the transmission of a continuation shall be resumed thereafter. This is judged by whether or not the entire data of the multimedia data has been transmitted. Alternatively, it may be judged by whether or not the multimedia data has been transmitted up to a specified position in the multimedia data.

In the case where it is judged that playing has ended, that is, transmission has ended, the Content Manager 405k removes the “currently played” attribute from the read attribute information, and updates the attribute information file in the second memory 203 by requesting the IO 405g, in the same manner as described above. When it is judged that playing has been paused, that is, transmission has been paused, the Content Manager 405k removes the “currently played” attribute from the read attribute information and further adds the “playing paused” attribute, and updates the attribute memory in the second memory 203 by requesting the IO 405g. It should be noted that, instead of being performed by the Content Manager 405k, the judgment for whether transmission has ended or transmission has been paused may be performed by the Java application, with the Content Manager 405k making an inquiry to the Java application. Furthermore, when it is judged that transmission has been paused, the pause position may be passed to the Java application and stored in the second memory 203. Furthermore, when storing the transmission pause position in the second memory 203, the transmission pause position may be added to the attribute information.

The Java library 405 is a collection of plural Java libraries stored in the second memory 203. In the present embodiment, the Java library 405 includes the JMF 405a, the AM 405b, the Tuner 405c, the CA 405d, the network library 405e, a playing Lib 405f, the IO 405g, an AWT 405h, an SI 405i, the Rec 405j, and so on.

Since the functions of the JMF 405a, the AM 405b, the Tuner 405c, the CA 405d, and the Rec 405j have already been described, further description shall be omitted.

The playing Lib 405f provides the classes and methods of the Java language (hereafter called Java API) for passing, to the Java program, the identifier of the channel currently played, which is stored in the second memory 203 or the identifier of the content recorded in the second memory 203. By using these Java APIs, the Java program is able to recognize the channel that is currently played.

The IO 405g provides, to the Java program, Java APIs for the writing of data to the second memory 203 by the Java program, or Java APIs for the reading of such data which has been written into the second memory 203. By using these APIs, the Java program is able to store arbitrary data in the secondary memory 203. Since such stored data is not erased even when power to the multimedia data transmitting apparatus 101 is turned off, the data can be read again after power to the multimedia data transmitting apparatus 101 is turned on.

The AWT 405h provides Java APIs for drawing or for the reception of a key input notification from the input unit 201 performed by the Java program. To be more specific, these correspond to the java.awt package, java.awt.event package, and other java.awt subpackages described in “The Java class Libraries Second Edition, Volume 2” (ISBN0-201-31003-1). Here, detailed description shall be omitted.

The SI 405i provides Java APIs for the obtaining of channel information and electronic TV-program list information by the Java program. To be more specific, there are the Java TV Specification and the like. Furthermore, the MPEG section filter API for obtaining raw binary data from an MPEG transport stream currently being broadcast is defined in the OCAP Specification, and the Java application can understand and handle unique electronic TV-program data that has been transmitted.

The network library 405e communicates with the multimedia data receiving apparatus 102 connected to the network 103, through the NET 401b4 of the library 401b of the OS 401. The communication includes the receiving of requests from the multimedia data receiving apparatus 102 and the transmission of a content list or EPG, and multimedia data, in response to the request. This is the same as the function of a Digital Media Server (DMS) defined by DLNA. For details, refer to the DLNA Guidelines.

The Content Manager 405k manages the contents stored in the multimedia data transmission apparatus 101 and the attributes of the contents, and performs the deletion of contents aside from the functions described above.

The Content Manager 405k provides Java APIs to the respective constituent elements of the Java library 405 and the downloaded Java application. In the case of the present embodiment, the Content Manager 405k assumes the configuration shown in FIG. 2 or FIG. 4.

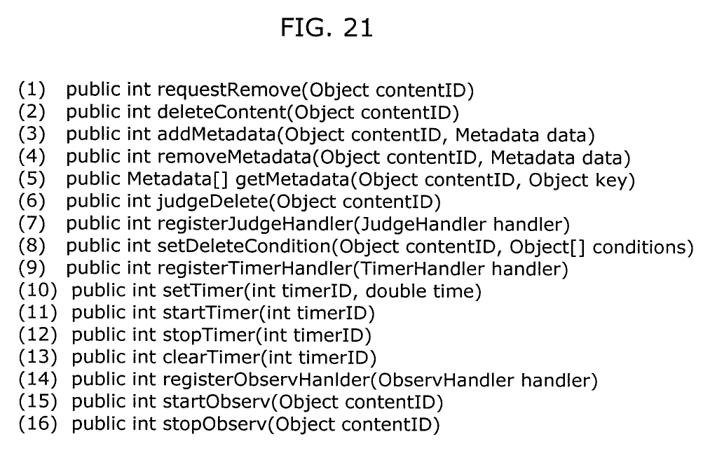

FIG. 21 is a diagram showing an example of the Java APIs provided by the Content Manager 405k. In FIG. 21, (1) and (2) are Java APIs provided to the downloaded Java application and the respective constituent elements of the Java library 405 by the content managing unit 2501 or the content managing unit 2601. Furthermore, (3), (4), and (5) are Java APIs provided to the downloaded Java application and the respective constituent elements of the Java library 405 by the attribute managing unit 2503 or the attribute managing unit 2603 via the content managing unit 2501 or the content managing unit 2601, respectively. (7) is a Java API provided to the downloaded Java application and the respective constituent elements of the Java library 405 by the judging unit 2502 or the judging unit 2602 via the content managing unit 2501 or the content managing unit 2601, respectively. Furthermore, in FIG. 21, (6) is a Java API provided in the judging unit 2502 or the judging unit 2602, (8) is a Java API provided in the deleting condition managing unit 2604, (9) to (13) are Java APIs provided in the timer managing unit 2605, and (14), (15), and (16) are Java APIs provided in the playing observing unit 2606, and these Java APIs are mainly used inside the Content Manager 405k. It should be noted that the Java APIs shown in FIG. 21 are only those that are related to the features of the present invention, and the Content Manager 405k also provides APIs that are not shown in FIG. 21 such as recording request acceptance and so on.

Method requestRemove( ) in FIG. 21(1) accepts a deletion request for a content provided by an argument contentID. The method requestRemove( ) returns 0 as the return value when the specified content is deleted, returns 1 as a return value when deletion is not possible, returns 2 as a return value when deletion is pending, and returns a negative integer representing an error code when an error occurs. Details of the operation of this method shall be described later.

Method deleteContent( ) in FIG. 21(2) deletes the content provided by the argument contentID. It returns 0 when deletion is successful, and returns a negative integer representing an error code when the deletion fails.

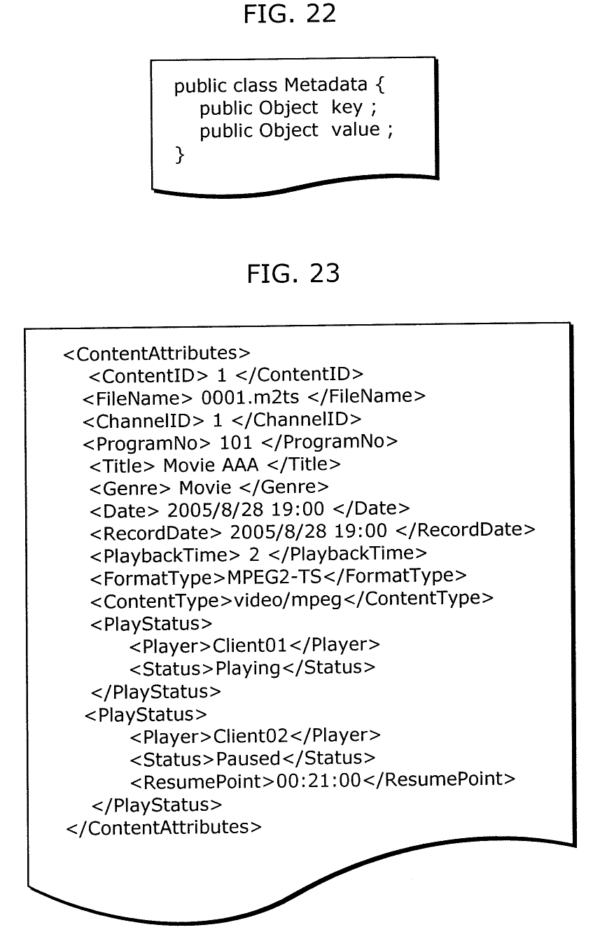

Method addMetadata( ) in FIG. 21(3) adds an attribute provided by an argument data to the content provided by the argument contentID. It returns 0 when successful and returns a negative value representing an error code in the case of failure. The argument data is an instance of a Metadata class. FIG. 22 is a diagram showing an example of the Metadata class. In FIG. 22, the Metadata class is configured of two member variables. Member variable key represents a key of metadata. It corresponds to the element names such as ContentID or FileName in the example of attribute information in FIG. 18, and is generally a character string. Furthermore, member variable value is a value related to a key provided by the member variable key, and corresponds to the content of the respective elements in the example of attribute information in FIG. 18. It should be noted that the member variable value may be an instance of the Metadata class or a set of instances of the Metadata class. FIG. 23 shows an example of a case where, for example, the “currently played” and “playing paused” attributes are set to each client used for playing.

FIG. 23 is a diagram showing another example of attribute information in the present embodiment.

In FIG. 23, contents of the PlayStatus element include at least a Player element and a Status element. For the Metadata instances of the PlayStatus element, the key is the character string PlayStatus, the value is the set which consists of the Metadata instance of the Player element and the Metadata instance of the Status element.

Method removeMetadata( ) in FIG. 21(4) removes the attribute provided by an argument data, from the content provided by the argument contentID. The method removeMetadata( ) returns 0 when removal is successful or when the attribute provided by the argument data was not added, and returns a negative integer representing an error code when an error occurs.

Method getMetadata( ) in FIG. 21(5) obtains the attribute related to a key provided by an argument key, of the content provided by the argument contentID. Since there are cases where plural attributes for the same key are set, the return value is an arrangement of Metadata instances. When successful, the method getMetadata( ) returns the arrangement of Metadata instances representing an attribute, and returns null in the case of failure.

Method judgeDelete( ) in FIG. 21(6) judges whether or not deletion of the content provided by the argument contentID is possible. The method judgeDelete( ) returns 0 when it judges that deletion is possible, 1 when it judges that deletion is not possible, 2 when it judges that the setting of the deleting condition is possible, and a negative integer representing an error code in the case of an error. Details of this method shall be described later.

The method registerJudgeHandler( ) in FIG. 21(7) registers, as a handler, an instance of a JudgeHandler interface provided by an argument handler, and returns 0 when successful and a negative integer representing an error code in the case of failure.

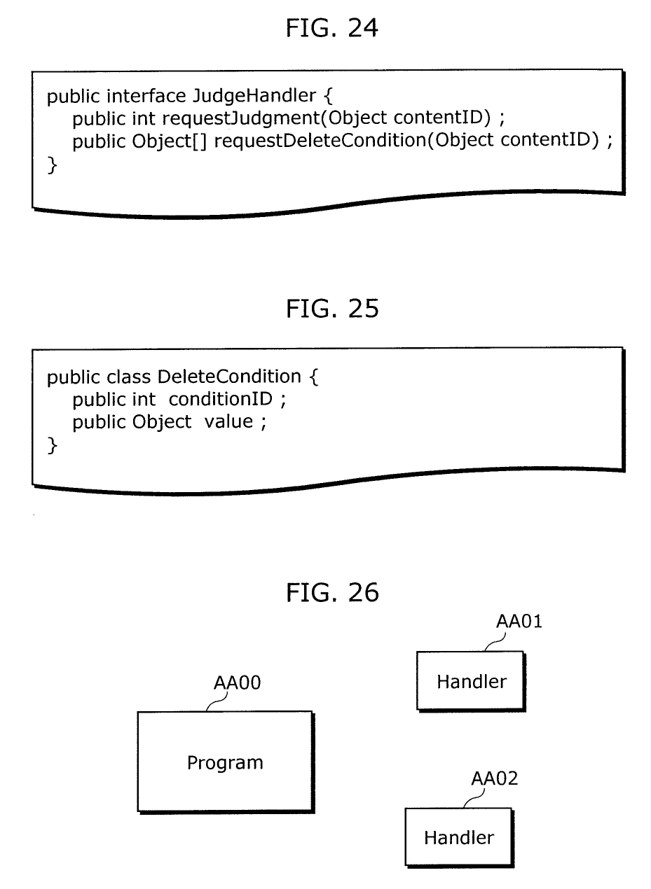

FIG. 24 is a diagram showing an example of the JudgeHandler interface. The JudgeHandler interface has two methods. Method requestJudgment( ) is a callback function which accepts the request of the judgment of whether or not it is possible to delete the content provided by the argument contentID. The Content Manager 405k inquires about the judgment of whether or not deletion is possible to the instance of the JudgeHandler interface registered through this method. The return value for this method is the same as that for the method judgeDelete( ). Furthermore, a method requestDeleteCondition( ) of the JudgeHandler interface is a callback function which inquires about the deleting condition regarding the content provided by the argument contentID. With this method, the Content Manager 405k receives the deleting condition for the content from the downloaded Java application or the like. The return value of this method is an arrangement of objects representing the deleting condition, and it returns null in the case of failure. FIG. 25 shows an example of a class representing the deleting condition which is the return value.

FIG. 20 is a diagram showing an example of a DeleteCondition class. The DeleteCondition class is configured of two member variables. Member variable conditionID represents the type of the deleting condition. In the present embodiment, 0 represents the passing of a specified time, and 1 represents the end of playing of the content. Furthermore, member variable value is a numerical value related to the deleting condition. In the present embodiment, the member variable value adopts a double value representing the specified time in seconds in the case where the condition is 0, and does not hold any meaning in other cases.

Here, a handler is an object having a specific interface. When a condition arises such as the occurrence of an event, a handler is notified by such interface and performs processing associated with the notification.

FIG. 26 is an explanatory diagram for describing handlers. In FIG. 26, handlers AA01 and AA02 respectively perform different processing. Either of the handler AA01 or the handler AA02 can be registered in a program AA00. Upon detecting that a certain condition is satisfied, the program AA00 calls the registered handler, and the processing provided in the called handler is performed. For example, when the handler AA01 is registered in the program AA00, the program AA00 calls the handler AA01 under a certain condition, and the processing provided in the handler AA01 is performed. By registering the handler AA02 in the program AA00 in place of the handler AA01, the program AA00 calls the handler AA02 under the same condition, and the processing provided in the handler AA02 is performed. Accordingly, by changing the registered handler, without changing the program AA00 itself, it is possible to change the processing for when the specific condition is satisfied.

It should be noted that the downloaded Java application itself, an object prepared by the Java application, an object held by the Content Manager 405k, and so on, can be used as the instance of the JudgeHandler interface.

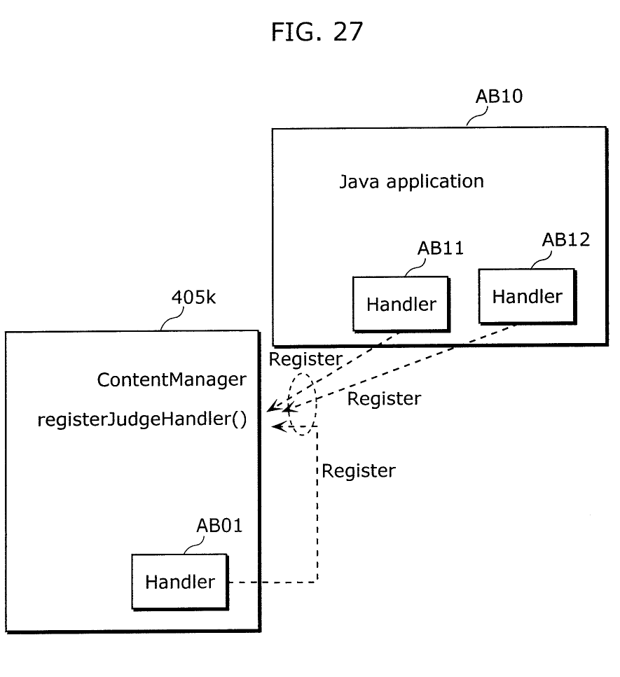

FIG. 27 is a diagram showing the operation in which a handler is registered through the method registerJudgeHandler( ). In FIG. 27, handlers AB01, AB11, and AB12 are registered through the method registerJudgeHandler( ). For example, when the handler AB01 is registered using the registerJudgeHandler( ), the Content Manager 405k can call the registered handler AB01 using the JudgeHandler interface.

It should be noted that, as shown in FIG. 27, the handlers in the present embodiment may exist inside the Content Manager 405k, or may exist inside a Java application AB10.

Method setDeleteCondition( ) in FIG. 21(8) registers an element provided by an argument conditions, as the deleting condition for the content provided by the argument contentID. With this method, the deleting condition is set to the Content Manager 405k and, when the set deleting condition is satisfied thereafter, the Content Manager 405k deletes the content by using the method deleteContent( ).

Method registerTimerHandler( ) in FIG. 21(9) registers, as a handler, an instance of a TimerHandler interface provided by the argument handler, and returns 0 when successful and returns a negative integer representing an error code in the case of failure.

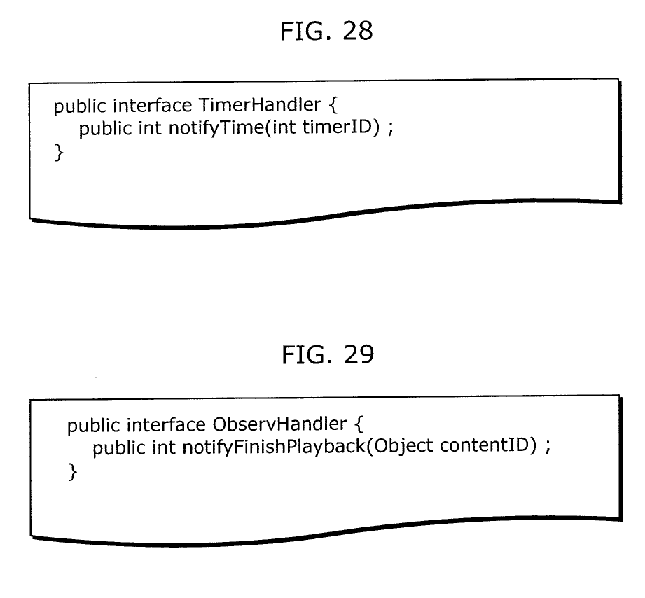

FIG. 28 is a diagram showing an example of the TimerHandler interface. The TimerHandler interface includes at least a method notifyTime( ). The method notifyTime( ) is a callback function which notifies the fact that a timer provided by an argument timer ID has reached the specified time.

Method setTimer( ) in FIG. 21(10) sets a time provided by an argument time to a timer of an identifier provided by an argument timerID, and returns a positive integer representing the identifier of the timer when successful, and returns a negative integer representing an error code in the case of failure. When a valid identifier is provided by the argument timerID, the resetting of the timer provided by such identifier is performed. In such case, the return value is the same value as that of the argument timerID. Furthermore, when an invalid identifier is provided by the argument timerID, the method setTimer( ) generates a new timer, sets the time, and returns the identifier of the generated timer. Although the time is specified in seconds in the present embodiment, the same effect can be attained even with another method of specifying.

Method startTimer( ) in FIG. 21(11) starts the timer provided by the argument timerID, and returns 0 when successful, and returns a negative integer representing an error code in the case of failure. Failure occurs when an identifier of an invalid timer is provided or when an identifier of a cleared timer is provided.

Method stopTimer( ) in FIG. 21(12) stops the timer provided by the argument timerID, and returns 0 when successful, and returns a negative integer representing an error code in the case of failure. The stopped timer can be started again by the method startTimer( ) as long as it is not cleared by a method clearTimer( ) to be described later.

The Method clearTimer( ) in FIG. 21(13) clears the value of the timer provided by the argument timerID, and returns 0 when successful, and returns a negative integer representing an error code in the case of failure. With this method, the timer cannot be started or stopped unless a value is set again by the method setTimer( ).

Method registerObservHandler( ) in FIG. 21(14) registers, as a handler, an instance of an ObservHandler interface provided by the argument handler, and returns 0 when successful and returns a negative integer representing an error code in the case of failure.

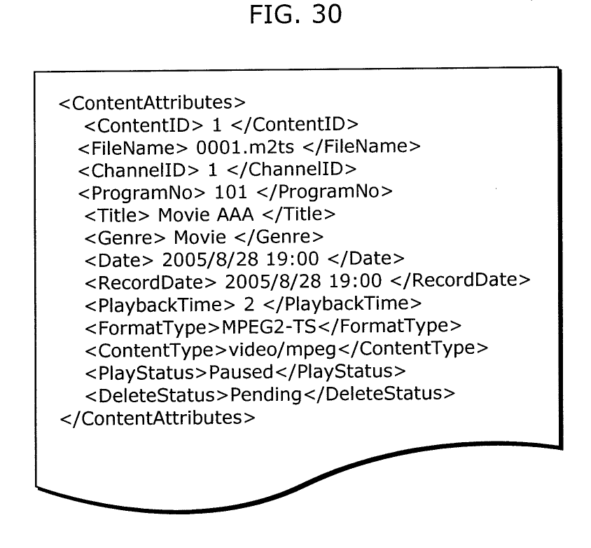

FIG. 29 is a diagram showing an example of the ObservHandler interface. The ObservHandler interface includes at least a method notifyFinishPlayback( ). The method notifyFinishPlayback( ) is a callback function which notifies the fact when the content provided by the argument contentID has the “currently played” or “playing paused” attribute and changes to a state where it does not have the “currently played” and “playing paused” attribute.

Method startObserv( ) in FIG. 21(15) starts the observation of the playing status of the content provided by the argument contentID, and returns 0 when successful, and returns a negative integer representing an error code in the case of failure. With this method, the observation of the playing status of the content is started, and a notification is made by the method notifyFinishPlayback of the ObservHandler interface when the content has been played until the end and changes to a state of not having the “currently played” and “playing paused” attribute.

Method stopObserv( ) in FIG. 21(16) stops the observation of the playing status of the content provided by the argument contentID, and returns 0 when successful, and returns a negative integer representing an error code in the case of failure.

Hereinafter, the operation of the methods requestRemove( ) and judgeDelete( ) shall be described.

First, the case where the multimedia data transmitting apparatus 101 operates according to the flowchart shown in FIG. 3 shall be described. First, the operation of the method judgeDelete( ) shall be described. In this case, the method judgeDelete( ) judges that deletion is not possible when either the “currently played” or the “playing paused” attribute is added to the content. Consequently, when the method judgeDelete( ) is called, the Content Manager 405k first calls the method getMetadata( ) with the identifier of the content and “PlayStatus” as arguments, and obtains the PlayStatus attribute added to the content. When the return value is null, this indicates that the PlayStatus attribute is not added and thus, the method judgeDelete( ) judges that deletion is possible and returns 0, and ends the processing. Furthermore, when an arrangement of Metadata instances is returned, the method judgeDelete( ) checks the contents thereof and checks whether the value thereof indicates “Playing” or “Paused”. When the value indicates “Playing” or “Paused”, the method judgeDelete( ) judges that deletion is not possible and returns 1, and ends the processing. When the value is not “Playing” or “Paused”, the method judgeDelete( ) judges that deletion is possible and returns 0, and ends the processing.

Next, the processing by the method requestRemove( ) in such a case shall be described. When this method is called, the Content Manager 405k first calls the method judgeDelete( ) with the identifier of the content as an argument, and causes the judging of whether or not deletion is possible. When the return value is 0 which indicates that deletion is possible, the Content Manager 405k calls the method deleteContent( ) with the identifier of the content as an argument, and causes the deleting of the content. Furthermore, the return value received from the method deleteContent( ) is returned directly as the returned value of the method requestRemove( ), and processing ends. Furthermore, when the return value of the method judgeDelete( ) is 1 which indicates that deletion is not possible, the method requestRemove( ) also returns 1 indicating deletion is not possible, and ends the processing.

Furthermore, the case where the multimedia data transmitting apparatus 101 operates according to the flowchart shown in FIG. 5 shall be described. First, the operation of the method judgeDelete( ) shall be described. In this case, when the method judgeDelete( ) is called, the Content Manager 405k first calls the method getMetadata( ) with the identifier of the content and “PlayStatus” as arguments, and obtains the PlayStatus attribute added to the content (step S001). When the return value is null, this indicates that the PlayStatus attribute is not added and thus, the method judgeDelete( ) judges that deletion is possible (No in step S002) and returns 0, and ends the processing. Furthermore, when an arrangement of Metadata instances is returned, the method judgeDelete( ) checks the contents thereof and checks whether the value thereof indicates “Playing” or “Paused”. When the value is not “Playing” or “Paused”, the method judgeDelete( ) judges that deletion is possible (No in step S002) and returns 0, and ends the processing. When the value indicates “Playing” or “Paused”, the method judgeDelete( ) next judges whether or not setting of a deleting condition is possible (step S003). This may be performed using other attributes such as whether or not the user has set deletion-not-possible for the content. When the setting of a deleting condition is possible, the method judgeDelete( ) returns 2 and ends the processing. Furthermore, when the setting of a deleting condition is not possible, the method judgeDelete( ) returns 1 indicating such fact, and ends the processing.

Next, the processing by the method requestRemove( ) in such a case shall be described. When this method is called, the Content Manager 405k first calls the method judgeDelete( ) with the identifier of the content as an argument, and causes the judging of whether or not deletion is possible (step S002). When the return value is 0 which indicates that deletion is possible (No in step S002), the Content Manager 405k calls the method deleteContent( ) with the identifier of the content as an argument, and causes the deleting of the content (step S103). Furthermore, the Content Manager 405k returns the return value received from the method deleteContent( ), directly, as the return value of the method requestRemove( ), and ends the processing.

Furthermore, when the return value of the method judgeDelete( ) is 1 indicating that deletion is not possible (Yes in step S002), the Content Manager 405k also returns 1 indicating deletion is not possible as the return value of the method requestRemove( ), and ends the processing. Hereinafter, the processing in the case where the return value of the method judgeDelete( ) is 2, which indicates that the setting of a deleting condition is possible (Yes in step S003), shall be described. First, the Content Manager 405k adds the “deletion pending” attribute to the content.

FIG. 30 is a diagram showing an example of the attribute information in FIG. 18 to which the “deletion pending” attribute has been added. In FIG. 30, since the value of the DeleteStatus element is “Pending”, it is assumed to indicate the “deletion pending”. The Content Manager 405k first generates a Metadata instance and sets a character string “DeleteStatus” as the member variable key and a character string “Pending” as the value thereof. In addition, the Content Manager 405k calls the method setMetadata( ) with such Metadata instance and the identifier of the content as arguments, and adds the “deletion pending” attribute to the content. In addition, the Content Manager 405k generates the deleting condition. Since “Passing of a specified time or end of playing” is used as the deleting condition in the flowchart in FIG. 5, the Content Manager 405k generates two DeleteCondition instances. In the first, 1 which indicates the passing of a specified time is set in the conditionID and a double value indicating the specified time in seconds is set as the value. Furthermore, in the other DeleteCondition instance, 1 which indicates the playing end is set in the condition. The Content Manager 405k generates an arrangement from these two instances and calls the method setDeleteCondition( ) with the arrangement and the identifier of the content.

When the method setDeleteCondition( ) is called, the Content Manager 405k generates an object provided with a TimerHandler interface (referred to here as tHandler) and an object provided with an ObservHandler (referred to here as oHandler). The tHandler object is included in the deleting condition managing unit 2604, and performs the processing for when the notification of the passing of the set time is received from the timer managing unit 2605. Furthermore, the oHandler object is included in the deleting condition managing unit 2604, and performs the processing for when the notification of the detection of the end of the playing of a specified content is received from the playing observing unit 2606. Note that in the case where these objects have already been generated, such objects may be used.

Next, the Content Manager 405k calls the method registerTimerHandler( ) with the tHandler as the argument, and registers the tHandler. Furthermore, the Content Manager 405k calls the method registerObservHandler( ) with the oHandler as the argument, and registers the oHandler. In addition, the Content Manager 405k performs the setting of the timer by calling the method setTimer( ) with the specified time value as the argument, the time value is retrieved from the DeleteCondition instances received as the argument of the method setDeleteCondition( ), and receives the identifier of the timer. In addition, the Content Manager 405k causes the identifier of the timer and the identifier of the content to be stored in association with each other.

In addition, the Content Manager 405k calls the method startTimer( ) with the received identifier of the timer as an argument, and causes the timer to start. In addition, the Content Manager 405k calls the method startObserv( ) with the identifier of the content as an argument, causes the content playing status observation to start, ends the processing by the method setDeleteCondition( ), and returns to the processing of the method requestRemove( ). Next, when the processing of the method setDeleteCondition( ) is successful, the Content Manager 405k returns 2 which indicates playing pending, and ends the processing. Furthermore, when the processing of the method setDeleteCondition( ) fails, the Content Manager 405k returns the return value thereof, as it is, as a return value, and ends the processing.

In addition, the processing by the tHandler and the oHandler shall be described. First, the processing by the method notifyTime( ) of the tHandler shall be described. When this method is called, the Content Manager 405k first calls the method stopTimer( ) with the identifier of the timer as an argument, and causes the timer to stop. In addition, the Content Manager 405k calls the method clearTimer( ) with the identifier of the timer as an argument, and causes the timer to be cleared. In addition, the Content Manager 405k retrieves the identifier of the content to be deleted which has been previously stored in association with the identifier of the timer. In addition, the Content Manager 405k calls the method deleteContent( ) with the identifier of the content as an argument, causes the content to be deleted. The Content Manager 405k returns the return value received from the method deleteContent( ), as it is, as the return value, and ends the processing.

Next, the processing by the method notifyFinishPlayback( ) of the oHandler shall be described. When this method is called, the Content Manager 405k first calls the method getMetadata( ) with the identifier of the content and “PlayStatus” as arguments, and obtains the value of the PlayStatus element from among the attributes of the content. When the return value of the method getMetadata( ) is null, the Content Manager 405k judges that deletion is possible (No in step S204) and retrieves the identifier of the timer which has been stored in association with the identifier of the content. Next, the Content Manager 405k calls the method stopTimer( ) with the identifier of the timer as an argument, and causes the timer to stop. In addition, the Content Manager 405k calls the method clearTimer( ) with the identifier of the timer as an argument, and causes the timer to be cleared (step S102). In addition, the Content Manager 405k calls the method deleteContent( ) with the identifier of the content as an argument, causes the content to be deleted (step S103). The Content Manager 405k returns the return value received from the method deleteContent( ), directly, as the return value, and ends the processing. Furthermore, when the return value from the method getMetadata( ) is not null, the Content Manager 405k checks the value. When the value is “Playing” or “Paused” (Yes in step S204), the Content Manager 405k ends the processing. When the value is not “Playing” or “Paused”, the Content Manager 405k judges that deletion is possible (No in step S204) and performs the stopping/clearing of the timer (step S102) and the deletion of the content (step S103) in the same manner as described above, and ends the processing.

It should be noted that although, in the above description, the Content Manager 405k performs judgment when the method judgeDelete( ) is called, the Content Manager 405k may perform judgment by calling the method requestJudgment( ) of the registered JudgeHandler interface inside the method judgeDelete( ). In this case, the judgment may be performed by calling the method requestJudgment( ) when the “currently played” or “playing paused” attribute is added, or the judgment may be performed by calling the method requestJudgment( ) when the “currently played” or “playing paused” attribute is not added. Furthermore, the Content Manager 405k may perform the judgment by calling the method requestJudgment( ), without performing the judgment on the “currently played” or “playing paused” attribute.

In addition, although the Content Manager 405k generates the deleting condition in the above description, the Content Manager 405k may call the method requestDeleteCondition( ) of the registered JudgeHandler, and receive the deleting condition.

Next, the multimedia data receiving apparatus 102 shall be described.

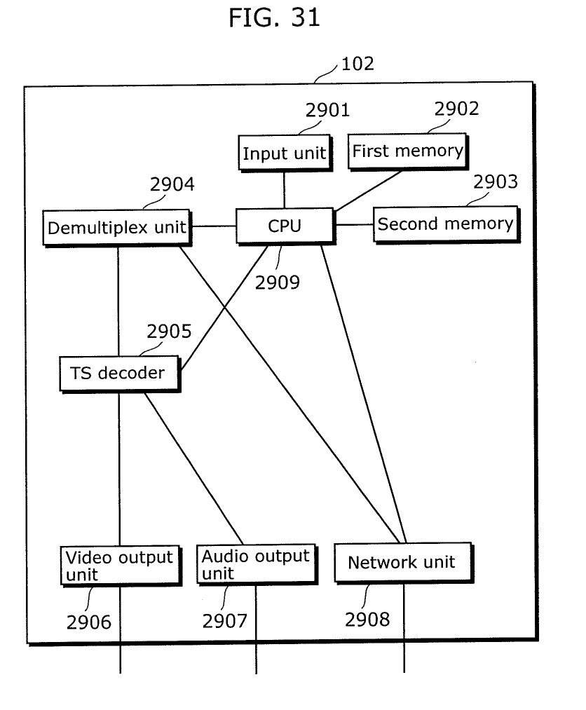

FIG. 31 is a block diagram showing the relationship of constituent elements of the multimedia data receiving apparatus 102 in the present embodiment. The multimedia data receiving apparatus 102 includes an input unit 2901, a first memory 2902, a second memory 2903, a demultiplex unit 2904, a TS decoder 2905, a video output unit 2906, an audio output unit 2907, a network unit 2908, and a CPU 2909.

The input unit 2901, the first memory 2902, and the second memory 2903 are identical to the input unit 201, the first memory 202, and the second memory 203 of the previously described multimedia data transmitting apparatus 101 in the present embodiment. Note that the multimedia data receiving apparatus 102 stores, in the second memory 2903, TV-program information such as the identifier, title, broadcast date and time, broadcast channel, and so on, of the multimedia data in the content list, EPG data, and so on, received from the multimedia data transmitting apparatus 101.

The demultiplex unit 2904 receives an MPEG transport stream from the CPU 2909, extracts information specified by the CPU 2909 and passes the extracted information to the CPU 2909. In addition, demultiplex unit 2904 passes the MPEG transport stream directly to the TS decoder 2905.

The TS decoder 2905 receives identifiers of audio data, video data from the CPU 2909. In addition, the TS decoder 2905 extracts data corresponding to the received identifiers of audio data and video data, from the stream received from the demultiplex unit 2904. The TS decoder 2905 passes extracted video data to the video output unit 2906, and audio data to the audio output unit 2907.

The video output unit 2906 and the audio output unit 2907 are identical to the video output unit 208 and the audio output unit 209, respectively, of the previously described multimedia data transmitting apparatus 101 in the present embodiment.

The network unit 2908, which includes a network interface, converts the data received from the CPU 2909 into a signal that is in accordance with the physical media of the network to which the network interface is connected to, and outputs this signal. Furthermore, the network unit 2908 receives a signal from the network interface, converts the signal into a packet defined by the IP network, and passes the packet to the CPU 2909.

The CPU 2909 controls the demultiplex unit 2904, the TS decoder 2905, and the network unit 2908, by executing a program stored in the second memory 2903.

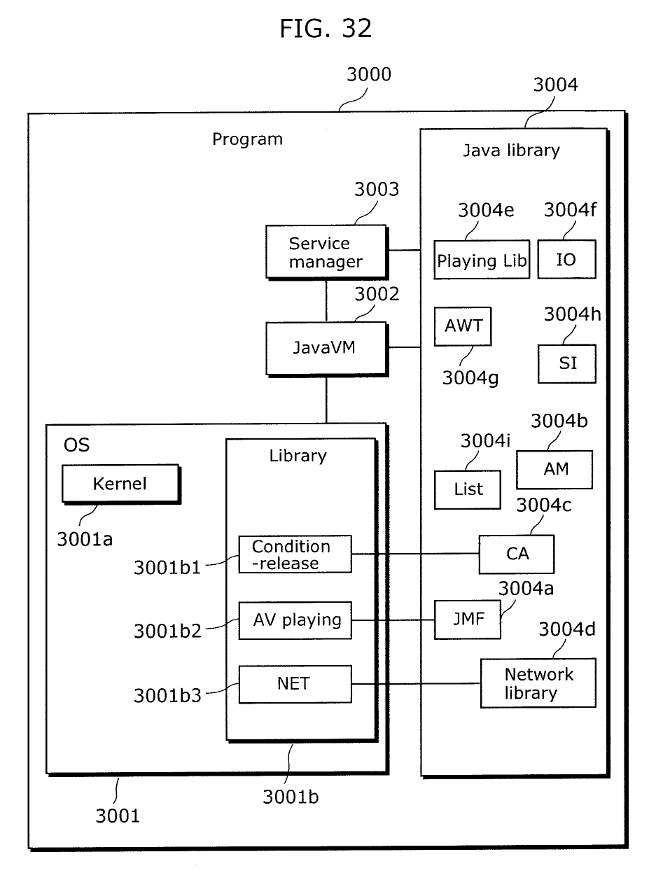

FIG. 32 is a structure diagram showing an example of the program stored in the second memory 2903 and executed by the CPU 2909.

A program 3000 is made up of a plurality of subprograms and specifically includes an OS 3001, a Java VM 3002, a service manager 3003, and a Java library 3004.

The OS 3001 is a subprogram activated by the CPU 2909 when power to the multimedia data receiving apparatus 102 is turned on. OS is the acronym for operating system, an example of which is Linux and the like. The OS 3001 is a generic name for publicly known technology made up of a kernel 3001a for executing another subprogram concurrently, and of a library 3001b, and therefore detailed description shall be omitted. In the present embodiment, the kernel 3001a of the OS 3001 executes the Java VM 3002 as a subprogram. Furthermore, the library 3001b provides these subprograms with plural functions for controlling the constituent elements held by the multimedia data receiving apparatus 102.

In the present embodiment, the library 3001b includes condition-release 3001b1, AV playing 3001b2, and NET 3001b3, as an example of functions.

The condition-release 3001b1 receives information from other subprograms and a CA 3004c of the Java library 3004, enables the AV playing 3001b2, and permits the playing of the multimedia data received from the network.

The AV playing 3001b2 receives an audio packet ID and video packet ID from the other subprograms and a JMF 3004a of the Java library 3004. It then provides the received audio packet ID and video packet ID to the TS decoder 2905. As a result, the TS decoder 2905 performs filtering based on the provided packet IDs, and implements the playing of audio/video.

The NET 3001b3 creates the data received from the other subprograms and a network library 3004d of the Java library 3004 into packets of a protocol lower than the application layer defined in the IP network. Packets of a protocol lower than the application layer refers to, for example, a TCP packet, a UDP packet, an IP packet, and so on. By passing this to the network unit 2908, messages and data are transmitted to another device via the network 103. Furthermore, when a message is received from another device via the network 103, the NET 3001b3 converts the message to an application layer protocol packet and passes this to the other subprograms and the network library 3004d of the Java library 3004. An application layer protocol refers to, for example, HTTP, RTSP or RTP, and so on.

The Java VM 3002 is identical to the Java VM 403 of the previously described multimedia data transmitting apparatus 101 in the present embodiment.

The service manager 3003 is identical to the service manager 404 of the previously described multimedia data transmitting apparatus 101 in the present embodiment except for the following points of difference. The service manager 404 receives a channel identifier from the playing unit 402b of the EPG 402; passes the identifier to the Tuner 405c and causes the Tuner 405c to perform tuning; performs descrambling by requesting the CA 405d; and requests the playing of video and audio with the channel identifier to the JMF 405a. Whereas, the service manager 3003 receives the content identifier from a List 3004i inside the Java library 3004; passes the content identifier as well as information on the apparatus storing such content identifier, and so on, to the network library 3004d and receives a stream from the apparatus; then requests for the playing of video and audio with the content identifier to the JMF 3004a inside the Java library 3004. The List 3004i shall be described later.

The service manager 3003 provides, to the network library 3004d inside the Java library 3004, information such as the content identifier and the IP address of multimedia data transmitting apparatus 101, and information such as the URI for accessing the content; requests the multimedia data transmitting apparatus 101 for the issuance of a multimedia data transmission request and the reception of the multimedia; and in addition requests the network library 3004d to receive the multimedia data transmitted from the multimedia data transmitting apparatus 101. Upon receiving the request, the network library 3004d connects to the multimedia data transmitting apparatus 101, and issues the transmission request for the multimedia data. Subsequently, the network library 3004d passes the data transmitted by the multimedia data transmitting apparatus 101 to the CPU 2902. The service manager 3003 is able to pass the received multimedia data to the demultiplex unit 2904 and carry out the playing of the multimedia data.

Note that with regard to trick play such as fast forward, rewind, and so on, the service manager 3003 requests trick play to the JMF 3004a described later, and in addition, performs trick play by requesting the network library 3004d to sequentially receive data necessary for trick play. Alternatively, trick play may be performed by specifying a playing speed conforming to the type of the trick play to the multimedia data transmitting apparatus 101, and the multimedia data transmitting apparatus 101 selects and transmits data conforming to the playing speed.

The Java library 3004 is a collection of plural Java libraries stored in the second memory 2903. In the present embodiment, the Java library 3004 includes the JMF 3004a, an AM 3004b, the CA 3004c, the network library 3004d, a playing Lib 3004e, the List 3004i, and so on.

The JMF 3004a, the AM 3004b, the playing Lib 3004e, an IO 3004f, an AWT 3004g, an SI 3004h are identical to the JMF 405a, the AM 405b, the playing Lib 405f, the IO 405g, the AWT 405h, and the SI 405i, respectively, which are located inside the Java library 405 of the previously described multimedia data transmitting apparatus 101 in the present embodiment.

The CA 3004c manages rights processing of the multimedia data, such as the copy control for the multimedia data transmitted via the network 103. Copy control information may be transmitted from he multimedia data transmitting apparatus 101, the content providers such as the broadcast station 105, or an external server specified by the rights holder. Or, it is also be acceptable that copy control information included in the PMT in a transport stream transmitted from a content information transmitting apparatus.

The List 3004i displays an EPG of the multimedia data transmitting apparatus 101 or a list of multimedia contents stored and provided by the multimedia data transmitting apparatus 101, selects one multimedia content from the list according to a user's operation accepted by the input unit 2901, and requests playing to the service manager 3003. At this time, information on the multimedia data transmitting apparatus 101 is also passed to the service manager 3003. Furthermore, the EPG of the multimedia data transmitting apparatus 101 and the list of contents to be provided from the multimedia data transmitting apparatus 101 can be obtained through the network library 3004d. Note that the List 3004i may also be included in the network library 3004d.

The network library 3004d communicates with the multimedia data transmitting apparatus 101 connected to the network 103, through the NET 3001b3 of the OS 3001b. The communication with the multimedia data transmitting apparatus 101 includes multimedia data list transmission/reception, multimedia data transmission request issuance and reception of the multimedia data. This is the same as the function of a Digital Media Player (DMP) defined by DLNA. For details, refer to the DLNA Guidelines. Furthermore, the communication with the multimedia data transmitting apparatus 101 further includes requesting deletion of a content in the multimedia data transmitting apparatus 101. This is carried out using a DestroyObject action defined in UPnP AV CDS. For details, refer to the UPnP AV Specifications.

(Modifications)

Although the present invention is described based on the above-mentioned embodiments, it should be obvious that the present invention is not limited to such above-mentioned embodiments. The present invention also includes such cases as described below.

(1) Although described as a multimedia data transmitting apparatus in the above-described embodiment, the present invention may also be a management method relating to content deletion described as a function of the Content Manager 405k in the multimedia data transmission apparatus 101.

Furthermore, the present invention may also be a computer program for executing such method through a computer, or as a digital signal made from the computer program.

Furthermore, the multimedia data transmitting apparatus of the present invention may be a computer readable recording medium on which the computer program or the digital signal is recorded, such as a flexible disc, a hard disc, a CD-ROM, an MO, a DVD, a DVD-ROM, a DVD-RAM, a Blu-ray Disc (BD), a semiconductor memory, and so on. Furthermore, the multimedia data transmitting apparatus and the multimedia data receiving apparatus of the present invention may also be the computer program or the digital signal recorded on such recording media.

(2) Although, in the above-described embodiment, processing is performed on an entire content basis, the content may be divided into plural segments and processing may be performed on a per segment basis.

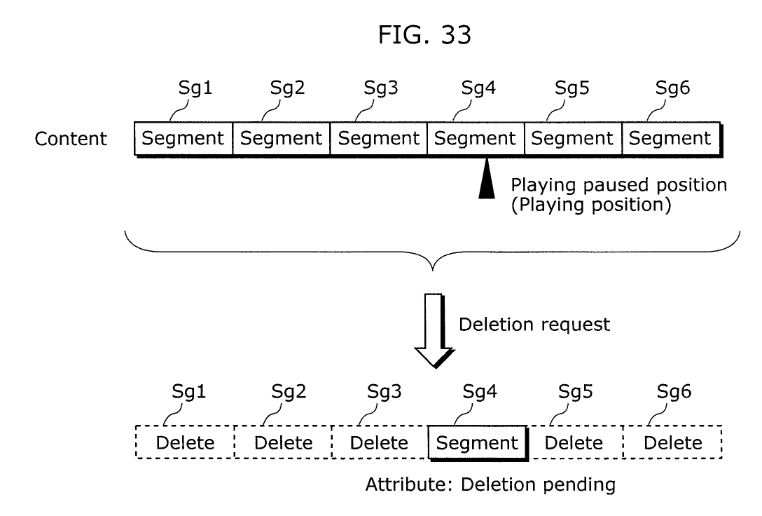

FIG. 33 is an explanatory diagram for describing the deletion of a segment as a unit of processing.

For example, a content is made up of the chronological divisions of plural segments Sg1 to Sg6. In this case, when the deletion of the content is requested, the judging unit 2502 or 2602 of the multimedia data transmitting apparatus 101 judge that deletion is not possible only for the segment Sg4 which includes the position of the current playing or the position at which playing has been paused. Conversely, the judging unit 2502 or 2602 judge that deletion is possible for the segments Sg1 to Sg3, and Sg5 and Sg6 other than the segment Sg4. As a result, the content managing units 2501 or 2601 of the multimedia data transmitting apparatus 101 adopts deletion pending to leave only the segment Sg 4 out of the content, and delete the segments Sg1 to Sg3, and Sg5 and Sg6.

Furthermore, even when a content is made up of plural segments, the multimedia data transmitting apparatus 101 may selectively handle and delete, either the entire content or a segment, as the unit of processing. Furthermore, when a content deletion request is received, deletion pending may be adopted for the segment for which playing is paused and the respective segments immediately preceding and following it, and other segments are deleted. In this case, “segments immediately preceding or following” may refer only to the preceding segment or only the following segment. Furthermore, plural preceding and following segments may be selected. Furthermore, any of these processes may be performed according to the specification by the Java application.

It should be noted that the segmenting of the content occurs when recording is resumed after the recording is suspended due to some cause such as power interruption during recording. Alternatively, the user may expressly divide the content.

(3) Although, in the above-described embodiment, processing is performed on an entire content basis, processing may be performed on a series in which plural contents such as a drama series are associated with each other.

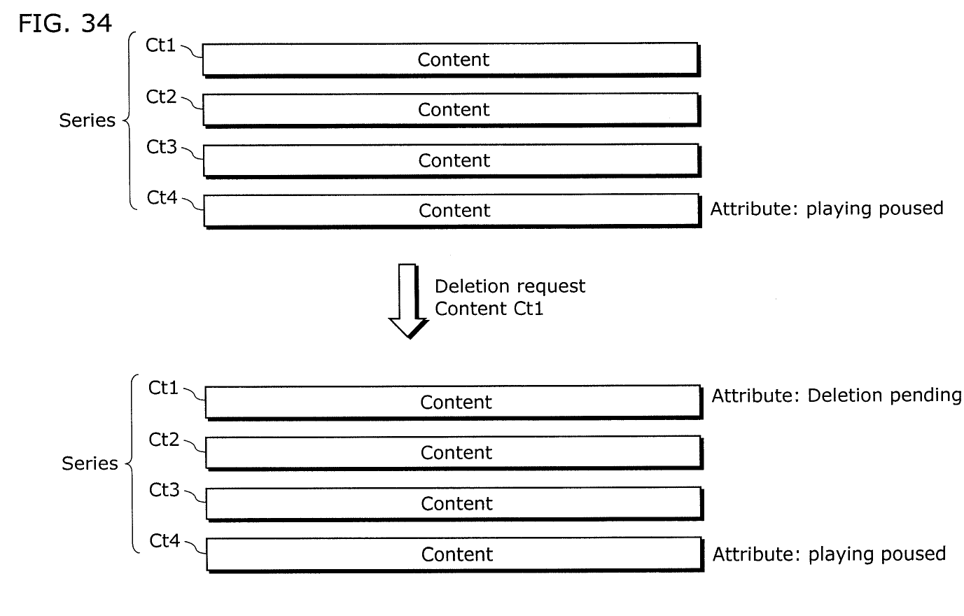

FIG. 34 is an explanatory diagram for describing the processing operation when the deletion of a content belonging to a series is requested.

For example, when a content deletion request is received, the multimedia data transmitting apparatus 101 performs the above-described judgment on all the contents belonging to the same series as the content, and the content is deleted when it is judged that deletion is possible. In other words, upon receiving a request to delete a content Ct 1 in the case where contents Ct1 to Ct4 are associated as one series, the judging units 2502 or 2602 checks the respective attributes of the contents Ct1 to Ct4 included in the series to which the content Ct1 belongs. Specifically, the judging units 2502 or 2602 judge whether or not at least one out of the respective attributes of the contents Ct 1 to Ct4 indicates “currently played” in which such content is in the state of being played or “playing paused” in which the playing of the content is paused. As a result, when it is judged that one of either of the states is indicated, the judging units 2502 or 2602 judge that deletion is not possible for the content Ct1 which is the target of the deletion request. As a result, the content managing units 2501 or 2601 do not delete the content Ct1 and assume deletion pending.

Furthermore, whether judgment is performed on the content or on the series to which the content belongs may be selected according to the specification by the Java application.

The series is generally set as a series-recording at the time when recording is scheduled, or set by user operation after recording. The present invention does not concern the method for setting the series.

Moreover, the management method and management format therefor is not considered in the present invention as long as the Java library 405 can recognize the series.

(4) Although, in the above-described embodiment, HTTP is used as the content data transmitting protocol, other protocols, such as RTP/RTSP, may be used.

(5) Although, in the above-described embodiment, only video content in the MPEG2-TS format is described, it goes without saying that the same processing can also be performed on video content in other coding formats and other types of content such as music.

(6) Although, in the above-described embodiment, the multimedia data transmitting apparatus 101 judges that playing has ended or playing is paused based on the terminating the HTTP connection for multimedia transmission, it may be expressly indicated from a client device. In such a case, the present invention is not dependent on the type of protocol by which the notification from the client device is performed.

(7) Although, in the above-described embodiment, either of the “currently played” and “playing paused” is mainly described as one attribute, a format in which these attributes are stored on a per client basis, as shown in FIG. 23, may also be adopted. Furthermore, a format in which a resume point for resuming playing is stored may be adopted. In addition, the resume point may be set in the “playing paused” attribute. The resume point may be obtained from the position at which the multimedia data transmitting apparatus 101 pauses the transmission, or may be expressly notified from a client device. In this case, the effect of the present invention is not dependent on the communication protocol by which the resume point is notified from the client device.

(8) Although, in the above-described embodiment, the subsequent content list transmission for a content with a “deletion pending” attribute, it is also acceptable not to transmit the information of the content with the “deletion pending” attribute at the time of content list transmission. Furthermore, it is also acceptable not to transmit the information of the content at the time of content list transmission, to the client device that issued the deletion request for the content. Furthermore, it is also acceptable to transmit the information of the content at the time of content list transmission, only to a client device for which the playing of the content is paused.

(9) It is acceptable that a part or all of the constituent elements making up each of the above-mentioned apparatuses is made from one system LSI (Large Scale Integration circuit). The system LSI is a super multi-function LSI that is manufactured by integrating plural components in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(10) It is acceptable that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(11) The multimedia data transmitting apparatus of the present invention may also be the above-described method.

Furthermore, the present invention may also be a computer program for executing such method through a computer, or as a digital signal made from the computer program.

Furthermore, the multimedia data transmitting apparatus of the present invention may be a computer readable recording medium on which the computer program or the digital signal is recorded, such as a flexible disc, a hard disc, a CD-ROM, an MO, a DVD, a DVD-ROM, a DVD-RAM, a Blu-ray Disc (BD), a semiconductor memory, and so on. Furthermore, the multimedia data transmitting apparatus of the present invention may also be the computer program or the digital signal recorded on such recording media.

Furthermore, the multimedia data transmitting apparatus of the present invention may also be the computer program or the digital signal transmitted via an electrical communication line, a wireless or wired communication line, a network represented by the Internet, a data broadcast, and so on.

Furthermore, the multimedia data transmitting apparatus of the present invention may also be a computer system including a microprocessor and a memory, with the memory storing the computer program and the microprocessor operating in accordance with the computer program.

Furthermore, the present invention may also be implemented in another independent computer system by recording the program or digital signal on the recording medium and transferring the recording medium, or by transferring the program or the digital signal via the network, and the like.

(12) Although, in the above-described embodiment, the passing of a specified time or the end of playing are assumed as the deleting condition, the falling of the remaining capacity of the second memory 203 below a specified value may be assumed as the deleting condition.

(13) It is also acceptable to combine the above-described embodiment and the aforementioned modifications.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The multimedia data transmitting apparatus and the multimedia data management method of the present invention has the remarkable effect of protecting the unintentional deletion of a content, in a multimedia server, for which playing is paused, and allowing a user to resume the playing of the content, in the sharing of multimedia contents in a multi-user, multi-client environment using a home network. Thus, the multimedia data transmitting apparatus and the multimedia data management method of the present invention is useful as a multimedia content server apparatus, a multimedia data transmission method, and so on, in a networked environment such as a home network.

What is claimed is:

1. A multimedia data transmitting apparatus which transmits multimedia data representing at least one of video and audio to a client device via a network, in response to a request from the client device, said multimedia data transmitting apparatus comprising:
a content managing unit configured to hold a content to be transmitted to the client device, as the multimedia data, and an attribute indicating a state of playing of a content; and
a judging unit configured to judge, when deletion of the held content is requested, whether or not the deletion is possible for at least a part of the content, based on the attribute,
wherein said judging unit is configured to judge that the deletion is possible when the attribute does not indicate either a state in which the content is being played or a state in which the playing of the content is paused, and to judge that the deletion is not possible when the attribute indicates the state in which the content is being played or the state in which the playing of the content is paused, and
said content managing unit is configured to delete the at least a part of the content when said judging unit judges that the deletion is possible.

2. The multimedia data transmitting apparatus according to claim 1,
wherein the content is chronologically divided into plural segments,
said content managing unit is configured to perform deletion on a per segment basis when the content is composed of the plural segments, and
said judging unit is configured to judge that the deletion is not possible for a segment which includes a position of current playing or a position at which playing is paused, among the plural segments.

3. The multimedia data transmitting apparatus according to claim 1,
wherein said content managing unit is further configured to hold a collection of contents that are associated as a series, and
said judging unit is configured to judge that deletion is not possible for the content for which the deletion is requested, when the attribute of at least one of the contents included in a same series as the content for which the deletion is requested indicates the state in which the content is being played or the state in which the playing of the content is paused.

4. The multimedia data transmitting apparatus according to claim 1,
wherein said judging unit further has a judgment condition other than the attribute and is configured to judge, according to the judgment condition, whether or not the deletion is possible for the content for which the deletion is requested, when the content for which the deletion is requested has the attribute.

5. The multimedia data transmitting apparatus according to claim 1, further comprising
a deleting condition managing unit configured to accept a deleting condition for allowing the deletion of a content,
wherein, when said judging unit judges that the deletion is not possible, said judging unit is configured to provide the deleting condition to said deleting condition managing unit, and
said deleting condition managing unit is configured to instruct the deletion of the content to said content managing unit when the deleting condition is satisfied.

6. The multimedia data transmitting apparatus according to claim 5,
wherein the attribute of the content indicates either a currently played state in which the content is being played or a playing paused state in which the playing of the content is paused, and
the deleting condition is that the attribute of the content is updated by said content managing unit so as not to indicate either of the currently played state or the playing paused state.

7. The multimedia data transmitting apparatus according to claim 5,
wherein said content managing unit is configured to hold plural attributes for the content,
the plural attributes of the content each indicate either a currently played state in which the content is being played or a playing paused state in which the playing of the content is paused, and
the deleting condition is that at least one of the plural attributes of the content is updated by said content managing unit so as not to indicate either of the currently played state or the playing paused state.

8. The multimedia data transmitting apparatus according to claim 5,
wherein said content managing unit is configured to hold plural attributes for the content,
the plural attributes of the content each indicate either a currently played state in which the content is being played or a playing paused state in which the playing of the content is paused, and
the deleting condition is that the plural attributes of the content are each updated by said content managing unit so as not to indicate either of the currently played state or the playing paused state.

9. The multimedia data transmitting apparatus according to claim 5,
wherein the deleting condition is the passing of a specified time.

10. The multimedia data transmitting apparatus according to claim 5,
wherein the deleting condition is that a remaining capacity of a recording media included in said multimedia transmitting apparatus, for recording the content has fallen below a specified value.

11. The multimedia data transmitting apparatus according to claim 1, further comprising
a Java executing unit configured to execute a Java application program,
wherein, when the attribute indicates the state in which the content is being played or the state in which the playing of the content is paused, said judging unit is configured to judge whether or not the deletion is possible for the at least a part of the content for which the deletion is requested by inquiring with the Java application program executed by said Java executing unit.

12. The multimedia data transmitting apparatus according to claim 11,
wherein the content is chronologically divided into plural segments,
said content managing unit is configured to perform deletion on a per segment basis when the content is composed of the plural segments, and
when receiving the inquiry from said judging unit, the Java application program selects one of the content and a segment which includes a position of current playing or a position at which playing is paused, and judges whether or not deletion is possible for the selected one of the content and the segment.

13. The multimedia data transmitting apparatus according to claim 11,
wherein said content managing unit is configured to hold a collection of contents that are associated as a series, and
when the attribute of at least one of the contents included in a same series as the content for which the deletion is requested indicates the state in which the content is being played or the state in which the playing of the content is paused, said judging unit is configured to judge whether or not the deletion is possible for the content by inquiring with the Java application program.

14. A multimedia data management method used in a multimedia data transmitting apparatus which transmits multimedia data representing at least one of video and audio to a client device via a network, in response to a request from the client device, said multimedia data management method comprising:
holding a content to be transmitted to the client device, as the multimedia data, and an attribute indicating a state of playing of a content;
judging, when deletion of the held content is requested, whether or not the deletion is possible for at least a part of the content, based on the attribute; and
deleting the at least a part of the content when it is judged in said judging that the deletion is possible,
wherein in said judging, it is judged that the deletion is possible when the attribute does not indicate either a state in which the content is being played or a state in which the playing of the content is paused, and judged that the deletion is not possible when the attribute indicates the state in which the content is being played or the state in which the playing of the content is paused.

15. The multimedia data management method according to claim 14,
wherein the content is chronologically divided into plural segments,
in said content managing step, deletion is performed on a per segment basis when the content is composed of the plural segments, and
in said judging step, it is judged that the deletion is not possible for a segment which includes a position of current playing or a position at which playing is paused, among the plural segments.

16. The multimedia data management method according to claim 14,
wherein in said holding, a collection of contents that are associated as a series is held, and
in said judging step, it is judged that deletion is not possible for the content for which the deletion is requested, when the attribute of at least one of the contents included in a same series as the content for which the deletion is requested indicates the state in which the content is being played or the state in which the playing of the content is paused.

17. The multimedia data management method according to claim 14, further comprising
executing a Java application program,
wherein, in said judging, when the attribute indicates the state in which the content is being played or the state in which the playing of the content is paused, judging whether or not the deletion is possible for at least a part of the content for which the deletion is requested is performed by inquiring with the Java application program executed in said executing.

18. The multimedia data management method according to claim 17,
wherein the content is chronologically divided into plural segments,
in said deleting, the deletion is performed on a per segment basis when the content is composed of the plural segments, and
when receiving the inquiry in said judging, the Java application program selects one of the content and a segment which includes a position of current playing or a position at which playing is paused, and judges whether or not deletion is possible for the selected one of the content and the segment.

19. The multimedia data transmitting apparatus according to claim 17,
wherein in said holding a collection of contents that are associated as a series is held, and
in said judging, when the attribute of at least one of the contents included in a same series as the content for which the deletion is requested indicates the state in which the content is being played or the state in which the playing of the content is paused, judging whether or not the deletion is possible for the content is performed by inquiring with the Java application program.

20. A computer program recorded on a computer-readable recording medium, for use in a multimedia data transmitting apparatus which transmits multimedia data representing at least one of video and audio to a client device via a network, in response to a request from the client device, said program causing a computer of the multimedia data transmitting apparatus to execute:
holding a content to be transmitted to the client device, as the multimedia data, and an attribute indicating a state of playing of a content;
judging, when deletion of the held content is requested, whether or not the deletion is possible for at least a part of the content, based on the attribute; and
deleting the at least a part of the content when it is judged in said judging that the deletion is possible,
wherein in said judging, it is judged that the deletion is possible when the attribute does not indicate either a state in which the content is being played or a state in which the playing of the content is paused, and judged that the deletion is not possible when the attribute indicates the state in which the content is being played or the state in which the playing of the content is paused.
